(19) United States
(12) Patent Application Publication
(10) Pub. No.: US 2009/0129386 A1
(43) Pub. Date: May 21, 2009

(54) Operator Shop Selection

(76) Inventor: Johan Rune, Lidingo (SE)

Correspondence Address: ERICSSON INC., 6300 LEGACY DRIVE, M/S EVR 1-C-11, PLANO, TX, 75024, US

(21) Appl. No.: 11/912,785

(22) PCT Filed: Apr. 29, 2005
(86) PCT No.: PCT/SE05/00645

§ 371 Date: Oct. 26, 2007

(51) Int. Cl. H04L 12/56

(52) U.S. Cl. 370/392

(57) ABSTRACT

An access node for an Ethernet network is connected between an access point of user devices and a broadband remote access server for access to a plurality of service providing networks. It includes a VLAN handling unit having a memory for storing identifications of Ethernet frames transmitted in a first VLAN including the access node and a local virtual router function unit of the access server in a second VLANs. Each of the second VLANs including the access node, the local virtual router function unit and one of the virtual router function units of the access server for each of the virtual router function units. A control unit commands the handling unit to transmit frames from a new user device that has connected itself to the access point into the first virtual local area network. The control unit also receives information from the access server in respect of routing frames and its commands to the handling unit to transmit frames from user device which is connected to the access point and the frames from which are transmitted into the first VLAN to be instead transmitted into one of the second VLAN as given by the information received from the broadband remote access server, the frames thereby being transmitted to the server of the respective service providing network.

### TECHNICAL FIELD

The present invention is generally related to digital communication systems, in particular to digital communication systems in which an end user accesses the rest of the system through an Ethernet network and which include broadband access to various services, and more particularly to operator shop selection by an end user in broadband access in a digital communication system.

### BACKGROUND AND PRIOR ART

Ethernet

Ethernet is the world's most pervasive networking technology.

Ethernet signals are transmitted from a station serially, one bit at a time, to every other station on the network. Ethernet uses a broadcast access method called Carrier Sense Multiple Access/Collision Detection (CSMA/CD) in which every computer on the network “hears” every transmission, but each computer “listens” only to transmissions intended for it. Each computer can send a message anytime it likes without having to wait for network permission. The signal it sends travels to every computer on the network. Every computer hears the message, but only the computer for which the message is intended recognizes it. This computer recognizes the message because the message contains its address. The message also contains the address of the sending computer so the message can be acknowledged. If two computers send messages at the same moment, a “collision” occurs, interfering with the signals. A computer can tell if a collision has occurred when it does not hear its own message within a given amount of time. When a collision occurs, each of the colliding computers waits a random amount of time before resending the message. The process of collision detection and retransmission is handled by the Ethernet adapter itself and does not involve the computer. The process of collision resolution takes only a fraction of a second under most circumstances. Collisions are normal and expected events on an Ethernet network. As more computers are added to the network and the traffic level increases, more collisions occur as part of normal operation. However, if the network gets too crowded, collisions increase to the point where they slow down the network considerably.

Any system based on collision detect must control the time required for the worst round trip through the LAN. As the term “Ethernet” is commonly defined, this round trip is limited to 50 microseconds (millionths of a second). At a signaling speed of 10 million bits per second, this is enough time to transmit 500 bits. At 8 bits per byte, this is slightly less than 64 bytes.

To make sure that the collision is recognized, Ethernet requires that a station must continue transmitting until the 50 microsecond period has ended. If the station has less than 64 bytes of data to send, then it must pad the data by adding zeros at the end.

To extend the LAN farther than the 50 microsecond limit will permit, one needs a bridge or router. These terms are often confused:

A repeater receives and then immediately retransmits each bit. It has no memory and does not depend on any particular protocol. It duplicates everything, including the collisions.

A bridge receives the entire message into memory. If the message was damaged by a collision or noise, then it is discarded. If the bridge knows that the message was being sent between two stations on the same cable, then it discards it. Otherwise, the message is queued up and will be retransmitted on another Ethernet cable. The bridge has no address. Its actions are transparent to the client and server workstations.

A router acts as an agent to receive and forward messages. The router has an address and is known to the client or server machines. Typically, machines directly send messages to each other when they are on the same cable, and they send the router messages addressed to another zone, department, or subnetwork. Routing is a function specific to each protocol. For IPX, the Novell server can act as a router. For SNA, an APPN Network Node does the routing. TCP/IP can be routed by dedicated devices, UNIX workstations, or OS/2 servers.

A block of data transmitted on the Ethernet is called a “frame.” The first 12 bytes of every frame contain the 6 byte destination address (the recipient) and a 6 byte source address (the sender). Each Ethernet adapter card comes with a unique factory installed address (the “universally administered address”). Use of this hardware address guarantees a unique identity to each card. PC software can be configured to substitute a different address number. When this option is used, it is called a “locally administered address.” The source address field of each frame must contain the unique address (universal or local) assigned to the sending card. The destination field can contain a “multicast” address representing a group of workstations with some common characteristic.

Each Ethernet board worldwide has a unique Ethernet-address, it is a 48 bit number (the first 24 bits indicate the manufacturer, the last 24 bits are a unique number for each Ethernet board/controller-chip assigned by the manufacturer). This is also called the MAC-address.

In normal operation, an Ethernet adapter will receive only frames with a destination address that matches its unique address, or destination addresses that represent a multicast message.

There are three common conventions for the format of the remainder of the frame:

Ethernet II or DIX

IEEE 802.3 and 802.2

SNAP

Ethernet II or DIX:

|Destination address|Source address|Type (Decnet, IPX or IP)|

Gigabit Ethernet Carrier Extension is a way of maintaining 802.3 minimum and maximum frame sizes with meaningful cabling distances. For carrier extended frames, the non-data extension symbols are included in the “collision window”, that is, the entire extended frame is considered for collision and dropped. However, the Frame Check Sequence (FCS) is calculated only on the original (without extension symbols) frame. The extension symbols are removed before the FCS is checked by the receiver. So the LLC (Logical Link Control) layer is not even aware of the carrier extension.

| | | | |
|---|---|---|---|
| \| Preamble | \| SFD \| DA \| SA \| Type/Length \| Data \| FCS | \| Extension | \| |
| | \| 64 bytes min | \| | |
| | \| 512 bytes min | | \| |

| | |
|---|---|
| \| Duration of Carrier Event | \| |
| SFD is a start of frame delimiter | |

|Preamble (7-bytes)|Start Frame Delimiter (1-byte)|Dest. MAC Address (6-bytes)|Source MAC Address (6-bytes)|Length/Type (2-bytes)|MAC Client Data (0-n bytes)|Pad (0-p bytes) |Frame Check Sequence (4-bytes)|

In 1998, the IEEE approved the 802.3ac standard that defines frame format extensions to support Virtual Local Area Network (VLAN) Tagging on Ethernet networks. The VLAN protocol permits insertion of an identifier, or “tag”, into the Ethernet frame format to identify the VLAN to which the frame belongs. It allows frames from stations to be assigned to logical groups. This provides various benefits such as easing network administration, allowing formation of work groups, enhancing network security, and providing a means of limiting broadcast domains. IEEE standard 802.1Q gives the definition of the VLAN protocol. The 802.3ac standard defines only the implementation details of the VLAN protocol that are specific to Ethernet.

If present, the 4-byte VLAN tag is inserted into the Ethernet frame between the Source MAC Address field and the Length/Type field. The first 2-bytes of the VLAN tag consist of the “802.1Q Tag Type” and are always set to a value of 0x8100. The 0x8100 value is actually a reserved Length/Type field assignment that indicates the presence of the VLAN tag, and signals that the traditional Length/Type field can be found at an offset of 4-bytes further into the frame. The last 2-bytes of the VLAN tag contain the following information

The first 3-bits are a User Priority Field that may be used to assign a priority level to the Ethernet frame.

The next 1-bit is a Canonical Format Indicator (CFI) used in Ethernet frames to indicate the presence of a Routing Information Field (RIF).

The last 12-bits are the VLAN Identifier (VID) which uniquely identifies the VLAN to which the Ethernet frame belongs.

With the addition VLAN tagging, the 802.3ac standard permitted the maximum length of an Ethernet frame to be extended from 1518-bytes to 1522-bytes. The following illustrates the format of an Ethernet frame that has been “tagged” with a VLAN identifier per the IEEE 802.3ac standard:

|Preamble (7-bytes)|Start Frame Delimiter (1-byte)|Dest. MAC Address (6-bytes)|Source MAC Address (6-bytes)|Length/Type=802.1Q Tag Type (2-bytes)|Tag Control Information (2-bytes)|Length/Type (2-bytes)|MAC Client Data (0-n bytes)|Pad (0-p bytes)|Frame Check Sequence (4-bytes)|

With introduction of the 802.3z standard for Gigabit Ethernet in 1998, an extension field was added to the end of the Ethernet frame to ensure it would be long enough for collisions to propagate to all stations in the network. The extension field is appended as needed to bring the minimum length of the transmission up to 512 bytes (as measured from the Destination Address field through the extension field). It is required only in half-duplex mode, as the collision protocol is not used in full-duplex mode. Non data bits, referred to as “extension bits”, are transmitted in the extension field so the carrier is extended for the minimum required time. The following illustrates a frame with an extension field appended:

|Preamble (7-bytes)|Start Frame Delimiter (1-byte)|Dest. MAC Address (6-bytes)|Source MAC Address (6-bytes)|Length/Type (2-bytes)|MAC Client Data (0-n bytes)|Pad (0-p bytes)|Frame Check Sequence (4-bytes)|Extension|

TCP/IP

TCP/IP uses IP-addresses, which are 32-bit numbers. To make it easier to memorize such IP-addresses, they are usually expressed as 4 8-bit numbers (example: 192.168.10.1), where each of the 4 numbers is within the range of ‘0’ to ‘255’ (there are restriction on using ‘0’ and ‘255’, avoid using them). When setting up a small private network, you are free to use ANY IP-address, however, when you are connected to a company network, you need to ask the Network-administrator to assign you an IP-address. And if you are connected to the Internet, your ISP (Internet Service Provider) will assign an IP-address to you.

DHCP (Dynamic Host Configuration Protocol)

On bootup, the system sends out a call on the network to find a DHCP-server, which assigns an IP-address to such a system. The IP-addresses are usually assigned NOT permanently, but for a specific time (could be days, weeks, months or on Internet-connections just for the ONE connection). If the system contacts the DHCP-server again during this time, the ‘lease’ on the IP-address is extended. But if you come back from a long vacation, your ‘lease’ of the IP-address may have expired, that IP-address may have been assigned now to somebody else, and you/your computer get now assigned a new IP-address.

The systems have IP-addresses, but Ethernet-boards ONLY know their Ethernet-address, so as soon as a TCP/IP configured system is switched on, it is advertising its presence onto the network: “Hey, I am alive, my Ethernet address is ‘08000b 0a0238’ and my IP-address is ‘192.168.10.2’ ” and each TCP/IP system on the network builds up a table with all this information, which is usually checked/verified in time-intervals of 15 min.

If your system needs now to communicate with a station, for which it does NOT have an entry in its table of IP/Ethernet-Addresses, it sends out a search-message to everybody (“Broadcast-Message”) like: “Hey, I like to communicate with the IP-address ‘192.168.10.4’, but I do NOT know your Ethernet-Address. Please, identify yourself”. This causes the system with the requested IP-address to send out its advertising again.

These processes are called ARP (Address Resolution Protocol) and RARP (Reversed Address Resolution Protocol).

The Address Resolution Protocol is used to dynamically discover the mapping between a layer 3 (protocol) and a layer 2 (hardware) address. A typical use is the mapping of an IP address (e.g. 192.168.0.10) to the underlying Ethernet address (e.g. 01:02:03:04:05:06). You will often see ARP packets at the beginning of a conversation, as ARP is the way these addresses are discovered. ARP is used to dynamically build and maintain a mapping database between link local layer 2 addresses and layer 3 addresses. In the common case this table is for mapping Ethernet to IP addresses. This database is called the ARP Table. Dynamic entries in this table are often cached with a timeout of up to 15 minutes, which means that once a host has ARPed for an IP address it will remember this for the next 15 minutes before it gets time to ARP for that address again.

Gateway/Router

To connect a TCP/IP local-area-network to another TCP/IP LAN (which could be the complete Internet) or via a Wide-Area-Network (WAN), you need now a device called Gateway or Router.

EAP

IEEE 802.1x adopts the Extensible Authentication Protocol (EAP) as the mechanism for exchange of authentication messages. EAP messages are encapsulated in Ethernet LAN packets (EAPOL) to allow communications between the supplicant and the authenticator.

EAP-TLS (Transport Layer Security). EAP-TLS is defined in RFC 2716 as the security method used in the 802.1x client in Windows XP. It provides for certificate-based, mutual authentication of the client and the network. It relies on client-side and server-side certificates to perform authentication; and distributes dynamically generated user- and session-based encryption keys to secure the connection. Mutual authentication and distribution of dynamic encryption keys are of particular interest in shared media Ethernet environments, such as 802.11 wireless LANs.

EAP-TTLS (Tunneled Transport Layer Security). EAP-TTLS (described in an IETF draft) is an extension of EAP-TLS, which requires only server-side certificates, eliminating the need to configure certificates for each client. TTLS provides additional security for transmission of user credentials and ciphers. It also supports legacy password protocols, so that it may be deployed as a front end to existing authentication systems (such as tokens or Microsoft Active Directory Services).

The evolution towards multiple services delivered over a broadband access network to an end user using an Ethernet type connection increases the end user need and business opportunity for a player to do service bundling, acting as a one point contact for the end user to access services from a plurality of service providers.

An access service provider (AccSP) provides the following basic services to its customers, including end users, enterprises or companies and application and content providers:

Access, i.e. the possibility to hook in to various networks

Connectivity, i.e. the possibility to connect to another user or service with required capabilities, speed, throughput, latency, etc.

Reachability, i.e. to provides the possibility for others to connect to you, i.e. providing an identifier for publication together with an appropriate service logic and interconnect services

Security from fraudulent or unwanted use of the access, including intrusion or eavesdropping.

An AccSP will also be dependent on identity and trust provisioning in order to identify and handle its customer relationships in an appropriate manner, including account handling.

From an IP and packet based perspective, AccSP basic offerings are:

Access rights

Connectivity

Reachability

all with the appropriate security level. If access over multiple points is offered, mobility becomes an intrinsic part of connectivity and reachability.

In one extreme case, the AccSP, called the operator shop, provides all services. The main asset of the operator shop is its direct relation to the end users. By having direct access to all necessary knowledge about the end user, the operator shop can create good service offerings and also provide the best quality in all aspects to the customer.

This does not mean that the operator shop will be capable of producing all services needed by the market, i.e. different kinds of end users, by itself alone. It will rather offer the complete service package together with partners such as application and content providers. The operator shop then provides a single interface and acts as an integrator, or shop, towards the users, also called subscribers.

Using the terminology of today the closest you get to an operator shop is an Internet service provider (ISP). Although there may actually be significant differences between an operator shop and an ISP, the two terms may be regarded as more or less equivalent as used herein. Hence, the operator shop selection mechanisms could also be labeled ISP selection mechanisms and would work equally well with ISPs as with operator shops.

The current invention relates to a method called Flexible service selection (FSS), see the pending International patent application No. PCT/SE03/01982, “Ethernet DSL access multiplexer and method providing dynamic service selection and end-user configuration”, filed Dec. 16, 2003, that is incorporated by reference herein.

FSS makes it possible to run a plurality of services from different application service providers (ASPs) simultaneously on a single personal computer (PC) or similar device in the customer premises network (CPN). Different services may be accessed through different gate-ways, having different media access control (MAC) addresses. It is assumed that the PC or similar device only gets one global IP (Internet Protocol) address, i.e. it may subscribe to only one ISP but to several ASPs.

The key to FSS is the use of DHCP (Dynamic Host Configuration Protocol) option 121 that allows traffic to be routed to different gateways depending on the IP address of the destination. When the PC requests an IP address through the DHCP it gets an answer according to DHCP option 121 including routing and gateway information relating to the services to which the user has subscribed. In the case where the PC does not support option 121 of the DHCP, the DSLAM (Digital Subscriber Line Access Multiplexer, Ethernet) has to snoop the information according to option 121 to be capable of mapping upstream traffic to the right virtual local area network (VLAN) and directing it to the right gateway as specified by the DHCP server. A VLAN is a logical grouping of ports and endstations such that all ports and endstations in the VLAN appear to be on the same physical (or extended) LAN segment even though they may be geographically separated. A VLAN identifier consists of a variable-length string of octets. The first octet in the string contains the number of octets in the remainder of the string, the actual VLAN identifier value. A VLAN identifier can be from 1 to 16 octets long.

Another related solution is the IP service engine (IPSE). Among other things it manages user traffic flows through a broadband remote access server (BRAS). IPSE can handle three levels of user authentication:

Authenticated users. When first connected, authenticated users need to provide a login name and password that are validated by the router network element, i.e. the BRAS, typically through the RADIUS protocol with an external authentication server:

Unauthenticated users. Unauthenticated users are granted a temporary connection and session with a minimum set of IP services. They can be authenticated at a later moment and be more officially logged-in by external business processes. During the later confirmed login of the users, the IPSE provides more explicit services and routing policies to the managed router.

Persistent users. Persistent users have been pre-registered in the routers (BRASs) and IPSE with the identification of the MAC addresses of their terminals. Sessions are created to manage connections that have been established without requiring any explicit authentication.

When coupled with the Ericsson Ethernet DSLAM access (EDA) network, the IPSE can register persistent users dynamically by memorizing the VMAC (Virtual MAC) identifiers or the identifiers according to option 82 of the DHCP.

Yet another solution related to operator shop selection is the IEEE 802.1x “Port-Based Network Access Control” standard. Appendix C of this standard document describes how the standard could be used together with a VLAN aware bridge in a local area network (LAN) context. One scenario described is when users can be connected to a nonauthenticated VLAN by default and then after authentication can be reassigned to another VLAN associated with authorized services. The VLAN configuration for the user's bridge port is thus changed. No VLAN mapping or VLAN de-tagging occurs.

Current solutions do not provide appropriate operator shop selection mechanisms that work in all access scenarios and for users roaming in foreign broadband access networks. A user roaming in a foreign broadband access network in this case refers to a user visiting an access network that has no direct relation to the user's home operator shop.

The FSS enables a device to access multiple services. However, it does assume that only one ISP, or single authority, e.g. the operator shop, has all knowledge about the services which the end user can access. Hence, the case where the end user may choose between several “operator shops” or ISPs is not handles by FSS. Further, the FSS method can probably not be used for users roaming in foreign broadband access networks.

The IPSE solution may be used as a platform to create operator shop selection. However, it does not describe how the authentication, authorization and accounting (AAA) architecture should be designed to support roaming users and it does not solve the problem associated with users roaming into a CPN behind a network address translator (NAT). In addition, the IPSE solution does not allow multiple users connected to the same port of a residential gateway (RG) to choose different ISPs, even when they are not connected through an NAT. Furthermore, the IPSE solution does not describe how the user login procedure is handled in conjunction with ISP selection.

The example described in the standard document IEEE 802.1x, appendix C using a non-authenticated VLAN could be used as a component in an operator shop selection solution. However, it does not describe the total solution with support for roaming users and users accessing the network from behind an NAT.

### SUMMARY

The present invention provides a solution for operator shop, or access service provider, which, in the context as used herein, can be regarded as more or less equivalent to an ISP selection by the end user in a broadband access network with multiple operator shops connected. When multiple operator shops are connected to the same broadband network a user accessing the network may have to indicate which of the operator shops that should provide the services. This applies to dynamically established session associations, i.e. when the association with an operator shop is not permanently tied to a physical attribute, such as an access port, but is instead created as a result of a user login or service access procedure. This solution can be valid for both users in their home network and roaming users. For a user accessing his home broadband network this means that he must indicate his home operator shop. For a user accessing a foreign broadband network it means that he must indicate an operator shop with which his home operator shop has a roaming agreement.

The current invention proposes a solution for operator shop, or AccSP, selection both for a user accessing his home broadband network and for the case when a roaming user is accessing a foreign broadband network. This is an important mechanism when mobility is introduced in the broadband access networks.

The solution for operator shop selection complements FSS in that it allows an end user to select the operator shop from which to access services. FSS, i.e. DHCP option 121, may then be used by the selected operator shop to provide the end user device with routing and gateway (GW) information to the different application services.

The operator shop selection solution further adds support for a roaming end user visiting a foreign broadband access network to select the desired visited operator shop.

The invention provides both layer 2 and layer 3 solution mechanisms. The layer 2 mechanisms are based on associations of the appropriate VLANs as triggered by a user authentication procedure, possibly complemented by manual indications on a service portal. The layer 3 mechanisms are based on IPsec (IP Security protocol suite, a set of standards used to provide security services at the IP layer) tunnels between the terminals and suitable endpoint or endpoints in the network using IKEv2 with the NAT traversal detection option and the extensible authentication protocol (EAP) as the integrated authentication mechanism.

The solution is comprehensive enough to cover a wide variety of access scenarios, including accessing the broadband access network through a dedicated RG port, a non-dedicated RG port, a home WLAN access point (AP), a home NAT, and a public WLAN AP, provided by the broadband access network.

### BRIEF DESCRIPTION OF THE DRAWINGS

FIG. 1 is a schematic view of the broadband access network architecture

FIG. 2a is a more detailed view of parts of the broadband access network that are relevant for operator shop selection,

FIG. 2b is a view similar to FIG. 2a where a WLAN AP does not support virtual APs,

FIG. 2c is a view similar to FIG. 2a where a terminal is connected to an RG via a router having an NAI,

FIG. 2d is a view similar to FIG. 2a where an IPsec tunnel passes in a BRAS and ends in a local VRF of the BRAS,

FIG. 2e is a view similar to FIG. 2a where an IPsec tunnel passes through a dedicated VRF, an operator shop, the Internet a BRAS and ends in a BAS of another operator shop,

FIG. 3a is a signal diagram of procedural steps executed when a terminal accesses an operator shop through a CPN,

FIG. 3b is a block diagram of an access node used in the case of FIG. 3a,

FIG. 4 is a diagram similar to FIG. 3a for a terminal accessing an operator shop through a wireless LAN access point supporting virtual APs,

FIG. 5 is a diagram similar to FIG. 4 for a terminal accessing a wireless LAN access point requesting/for obtaining information on available services,

FIG. 6a is a diagram similar to FIG. 4a for a terminal accessing an operator shop through a wireless LAN access point not supporting virtual APs, and

FIG. 6b is a block diagram of an access node used in the case of FIG. 6a.

### DETAILED DESCRIPTION

A system and method including procedures for operator shop selection that includes both layer 2 mechanisms and layer 3 mechanisms will now be described.

Overview of the Target Broadband Access Network Architecture

The network environment includes a broadband access network designed to serve roaming users, including both end users who roam within the broadband access network and end users who roam between the broadband access network and other access networks.

Roaming utilizing the AAA infrastructure is based on individual user identities in the form of network access identifiers (NAIs). The preferred authentication mechanism, that is also required for some parts of the system, is the extensible authentication protocol (EAP), see L. Blunk, J. Vollbrecht: “PPP Extensible Authentication Protocol (EAP)”, RFC 2284, March 1998, and L. Blunk et al.: “Extensible Authentication Protocol (EAP)”, <draft-ietfeap-rfc2284bis-06.txt> of the EAP Working Group, IETF, and the carrier for EAP is assumed to be designed according to the standard IEEE 802.1x-2001, “Port-Based Network Access Control”.

The legacy notion of a subscription in a broadband network is reused in the sense that a subscription is still tied to a physical attribute of a home, e.g. a communication port to which the residential gateway (RG) of the home is connected. Subscribed services are delivered to the RG using existing layer 2 mechanisms, i.e. per operator shop, and possibly per service, VLAN separation, MAC forced forwarding (MAC-FF), see T. Melsen, S. Blake, “MAC-Forced Forwarding: A Method for Traffic Separation on an Ethernet Access Network”, <draft-melsen-mac-forcedfwd-03.txt>, Personal Internet-Draft, IETF August 2004, Virtual MAC, see Kim Hyldgaard, “Virtual MAC Addresses in an Ethernet Access Scope”, DE13191A Uen, or antispoofing address filtering, etc. A VLAN dedicated to a certain operator shop is hereinafter referred to as a service VLAN or an operator shop VLAN.

Overlaid on these mechanisms it is also possible for individual users to receive services based on their user identities (NAIs). In this case the appropriate VLAN associations are dynamically established as a result of a user login procedure, whereas for services delivered to a certain RG, based on a physical attribute such as a communication port, these associations are permanent or semi-permanent. NAI based service delivery is required to allow roaming.

To allow volume based charging of traffic in another location than the user's home, where “home” is defined by the users subscription, as well as to allow, for legal purposes, tracing of traffic originating from the subscribers, it is essential that the source of traffic originating from a user in the broadband access network can be unambiguously identified. Thus, the traffic of each user has to be separated from other users' traffic. The basic method for accomplishing this in a broadband access network is a combination of the layer 2 mechanisms in VLANs, MAC-FF and virtual MAC or anti-spoofing address filtering. This applies both to connected customer premises networks (CPNs) and to connected WLAN (Wireless LAN) APs. However, there are also a number of differences between the case where a user is connected through a conventional local area network and the case where the user is connected through a wireless local area network, i.e. between the CPN case and the WLAN AP case:

All applicable service VLANs, for different operator shops, are constantly available through the WLAN AP, whereas in the CPN case, appropriate service VLANs are made available when needed, dynamically for NAI based sessions and at subscription time for (semi-)permanent associations.

For WLAN APs the service VLAN separation is, normally, extended across the radio interface through associations with separate service set identifiers (SSIDs) whereas in the CPN case each RG port may be associated. with a service VLAN, through VLANs or ATM PVCs to the access node (AN). However, WLAN APs that do not support multiple SSIDs can also be used in the method and system as described herein.

For WLAN APs traffic separation over the radio interface is achieved using cryptographic mechanisms according to the not yet finalized standard document IEEE 802.11i/D10.0, “Medium Access Control (MAC) Security, Enhancements”, April 2004, whereas traffic separation in a CPN, when applicable, is achieved by using separate RG ports, i.e. one individual port for each user.

However, the layer 2 based method for traffic separation requires that the considered user connects to a separate port of the RG when roaming into a CPN. This may be inconvenient in those cases where the terminals normally connect to the RG through a WLAN AP and/or an NAT. Moreover, in some cases a separate port may not even be available on the RG. Therefore, a layer 3 based method based on IPsec tunnels having source integrity and replay protection is also conceivable. This mechanism cryptographically ties the traffic to an individual user. In the system and method as described herein two basic alternatives are considered for the remote endpoint of the IPsec tunnel: the broadband remote access server (BRAS) and the broadband access server (BAS).

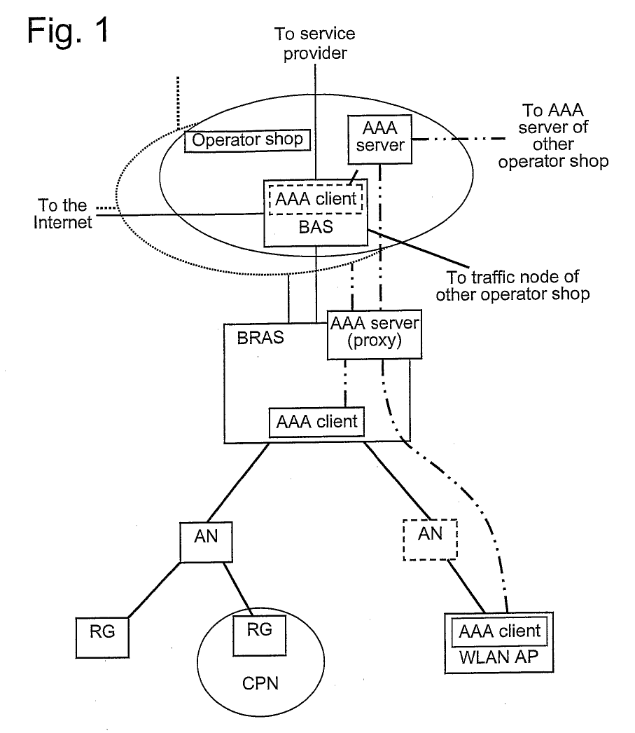

In FIG. 1 an architecture for a broadband access network is schematically illustrated in which the method as described herein is preferably performed, although the method is also applicable to various variations of the illustrated architecture. Primarily the location of the relevant nodes and AAA entities in the broadband access network are shown. The access node between the WLAN AP and the BRAS may not be needed. This depends on whether the required AN functionality, e.g. mechanisms for traffic separation, can be handled by the WLAN AP. An alternative to having an AAA client in the BRAS is to have an AAA client in each AN. Thus, as seen in FIG. 1 an AAA client is located in the BRAS. This AAA client is used for all accesses through CPNs in the broadband access network. Its location in the BRAS supports traffic separation on both layer 2, VLANs, MAC-FF, virtual MAC or anti-spoofing address filtering, and layer 3, IPsec tunnels. An AAA client is also located in each WLAN AP. This location supports traffic separation on layer 2, using the proposed standard IEEE 802.11i over the radio interface and VLAN, MAC-FF and anti-spoofing address filtering between the WLAN AP and the BRAS, employing the fact that many WLAN APs intended for public access have AAA clients implemented.

The BRAS also has an internal AAA server or is connected to an external AAA server. This AAA server acts as an AAA proxy server. It facilitates that the broadband access network serves multiple operator shops and allows the broadband network operator to apply its own AAA policies in addition to those applied by the operator shop selected by a user. The AAA server in the BRAS has a relation to an AAA server in each operator shop that the broadband access networks serves.

The AAA server that actually authenticates and authorizes users is located in the operator shop, since the operator shop “owns” the subscriber and manages the subscriptions.

The operator shop also has a broadband access server (BAS) for delivery of services and Internet traffic. There may be an AAA client in the BAS for communicating with the AAA server of the operator shop for authentication and authorization in conjunction with delivery of services to users roaming in other networks and possibly in conjunction with individualized delivery of services to users in the broadband access network, if a layer 3 traffic separation method is used.

The AAA protocol used between different AAA nodes, i.e. AAA servers and clients, is generally assumed to be RADIUS, see C. Rigney et al.: “Remote Authentication Dial In User Service (RADIUS)”, RFC 2865, June 2000, and B. Aboba, P. Calhoun: “RADIUS (Remote Authentication Dial In User Service) Support For Extensible Authentication Protocol (EAP)”, RFC 3579, September 2003. The AAA protocol can alternatively be Diameter, see P. Calhoun, J. Loughney, E. Guttman, G. Zom, J. Arkko: “Diameter Base Protocol”, RFC 3588, September 2003, and P. Eronen, Ed., T. Hiller, G. Zorn: “Diameter Extensible Authentication Protocol (EAP) Application”, Internet draft <draft-ietf-aaa-eap-03.txt>, IETF, October 2003. These two protocols can both convey EAP packets. Also, any other AAA protocol that can convey EAP packets can be used. However, EAP is not required for all parts of the method and system as described herein, in which cases the AAA protocol may also be some suitable protocol that cannot convey EAP packets.

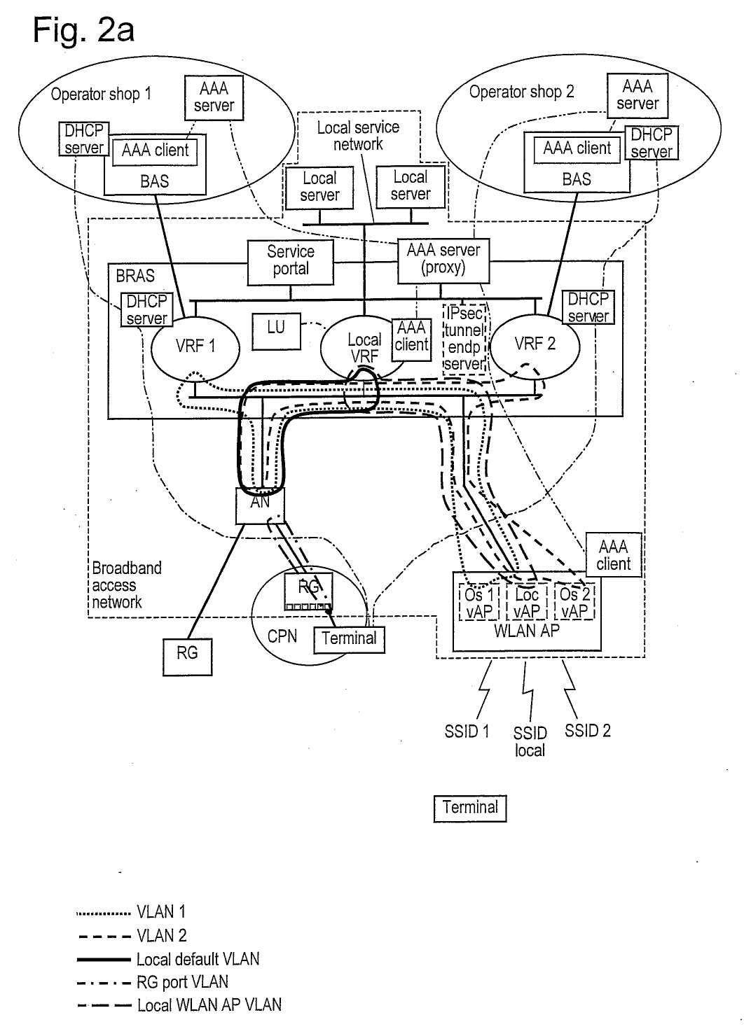

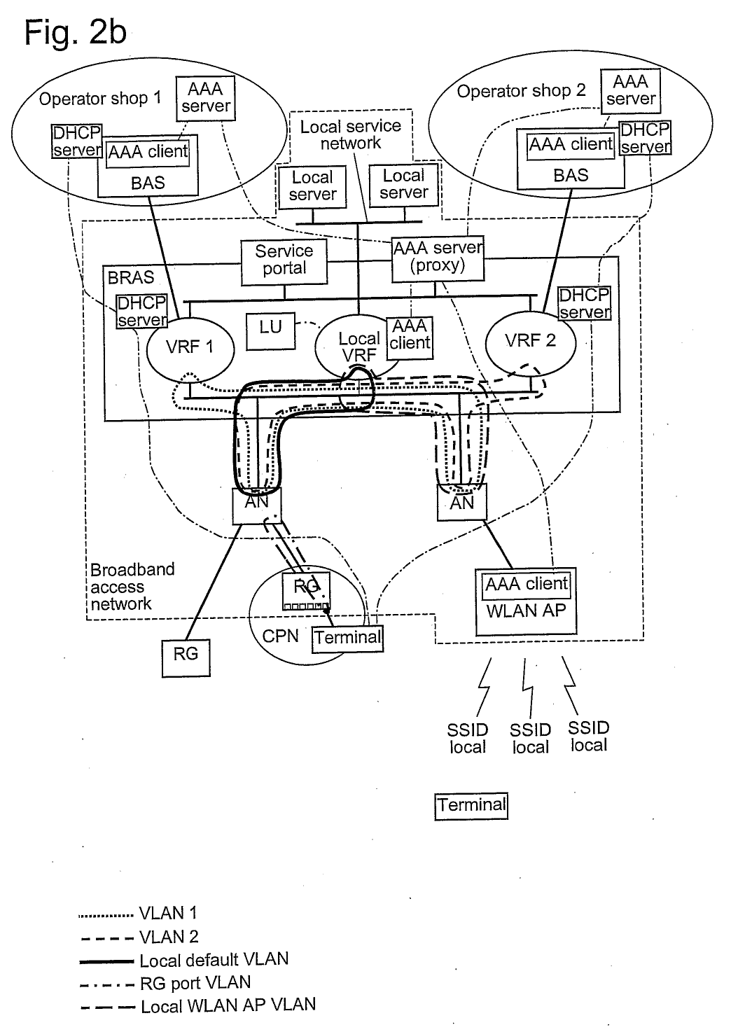

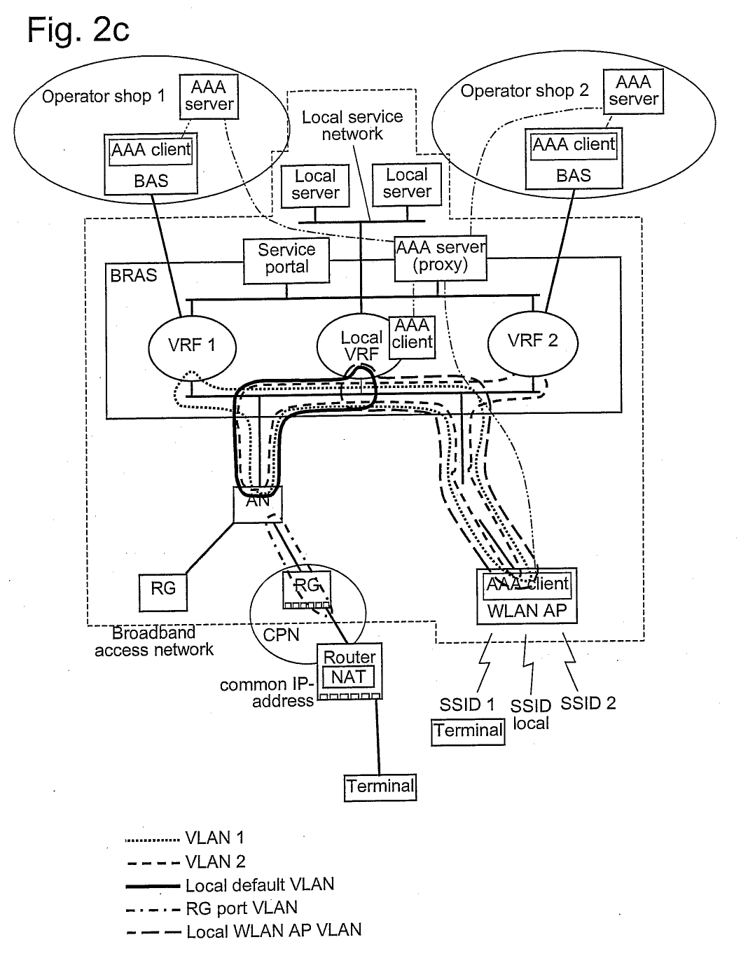

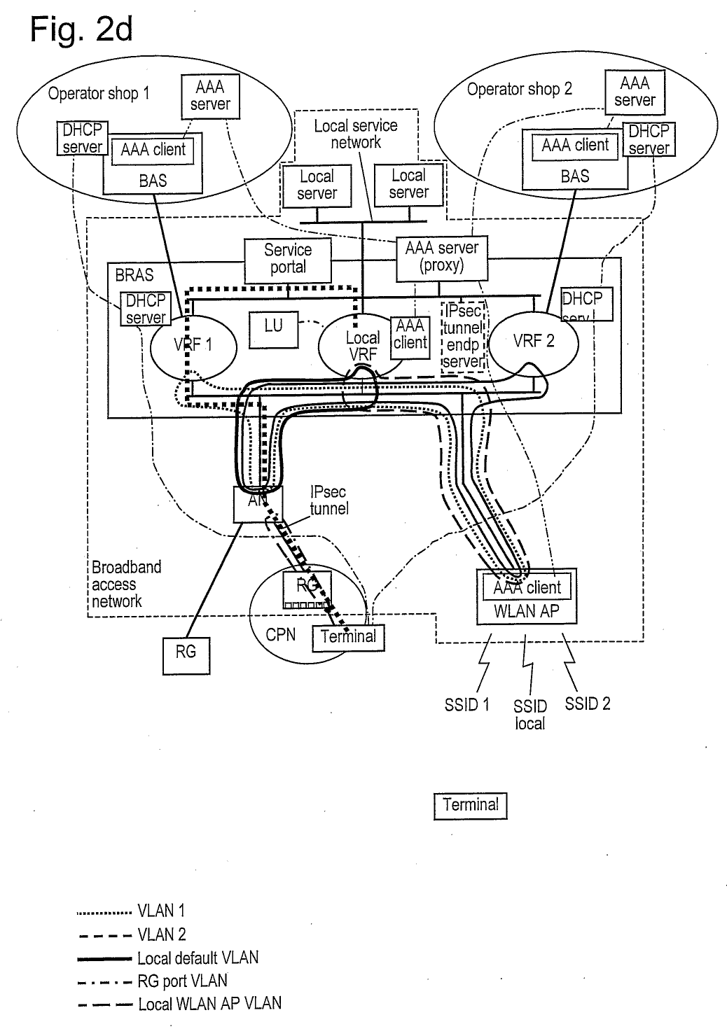

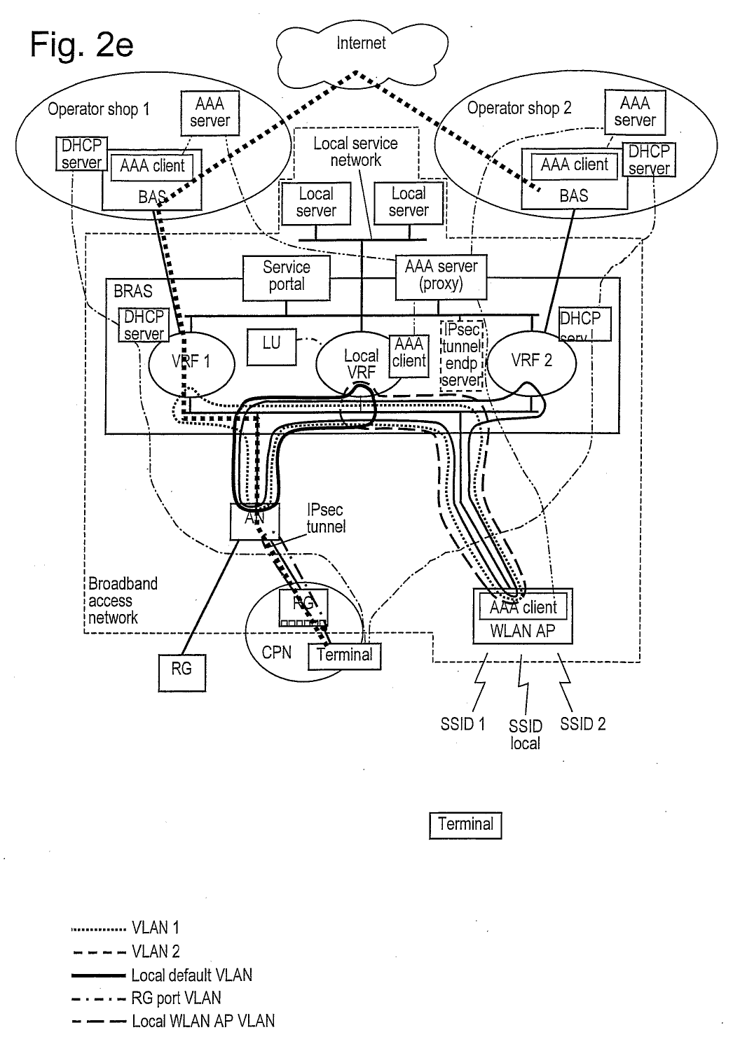

In addition to services supplied through the operator shops the broadband access network may provide local services, e.g. based on servers connected to a local service network connected to the BRAS, see the description of FIG. 2 below. Such local services are generally delivered for free to all users, including users roaming from other networks.

Operator Shop Selection Overview

A user is supposed to have a “home operator shop” and a “home access network”, the latter also called “home broadband network” or possibly “home broadband access network”, this term meaning a broadband access network through which the user's home operator shop can be reached directly, i.e. without using another operator shop, assuming there is a roaming agreement with the home operator shop, as a visited operator shop. The broadband access network thus serves the user's home operator shop, by providing a connection to the home operator shop, and is assumed to have a service agreement with this operator shop.

When multiple operator shops are connected to the same broadband access network a user accessing the network must indicate that one of the available operator shops which is to provide the services.

For a user accessing his home broadband access network this means that he must indicate his home operator shop. For a user accessing a foreign broadband access network, i.e. a broadband access network with which his home operator shop has no relation, it means that he must indicate an operator shop with which his home operator shop has a roaming agreement.

FIG. 2 is a more detailed view of those parts of the broadband access network that are relevant in conjunction with operator shop selection. The figure is used as a reference in the description of operator shop selection mechanisms below. It should be emphasized that the details of the architecture depicted in FIG. 2 should be seen as an exemplary embodiment. Various variations are possible, while still adhering to the basic principles of the method and system as described herein. However, also FIG. 2 is a simplified illustration. E.g. the AAA server of the BRAS is advantageously protected by security means, such as a firewall etc., not shown.

Two service VLANs, VLAN 1 and VLAN 2, each associated with an operator shop 1 and 2, respectively, are depicted. The other two VLANs are local VLANs, the local default VLAN and the local WLAN AP VLAN that are used for user authentication, this only performed by the local default VLAN, for operator shop selection and for access to local services.

The VRF (Virtual Router Function) 1 and the VRF 2 of the BRAS are each dedicated to a single operator shop. The local VRF of BRAS has a central role in the operator shop selection mechanisms, e.g. handling authentication and IPsec tunnels.

The local service network connected to the BRAS should also have a number of VLANs, not shown, configured so as to isolate VRF 1 and VRF 2 from each other, isolate servers from each other when applicable, etc. In the simplified schematic illustration the AAA server of the BRAS is shown to be connected to the same local service network as the local servers. However, it could be advantageous if this AAA server is connected to a separate network surrounded by more rigorous security measures, not shown. At least, the AAA server of the BRAS should be isolated and protected from unauthorized access by having a separation performed by a VLAN. The local VRF should preferably employ VLAN aggregation, according to D. McPherson, B. Dykes, “VLAN Aggregation for Efficient IP Address Allocation”, RFC 3069, February 2001, for the local service network, and the VLANs in which it may be divided, so that the local VRF can be reached using the same IP address from all other VRFs across the local service network. However, these VLANs in the local service network are not illustrated in FIG. 2.

There are two main cases for operator shop selection mechanisms to handle:

A user accessing his home broadband access network, i.e. a broadband access network that is connected to the user's home operator shop.

A user accessing a foreign broadband access network, i.e. a broadband access network that has no relation to the user's home operator shop.

Operator Shop Selection in a Home Broadband Access Network

The operator shop selection is not applicable for common services for all users or devices within a CPN in the case where the RG port of the CPN is (semi-)permanently associated with the home operator shop. In that case the operator shop has already been “selected” through the (semi-)permanent association. Only associations dynamically established per session are relevant.

The cases that should be considered in a home broadband access network include:

The user accesses the broadband access network through a CPN.

The user accesses the broadband access network through a WLAN AP.

The user accesses the broadband access network through an IPsec tunnel.

Access Through a CPN

The RG port VLAN of an RG port without an active session is by default associated with the local default VLAN. This association is present as a logical connection internally in the AN to which the RG is connected. That a VLAN is associated with another VLAN generally means that the VLANs are logically connected through a node, such as by a table entry in a table in the node, so that frames in one of the VLANs are automatically transmitted into the other VLAN. Thus, when a user connects to the RG port, the local default VLAN is all that he can reach, i.e. in this case frames received in the AN from the RG port are automatically transmitted into the local default VLAN. Before the user is authenticated, the procedures according to the standard document IEEE 802.1x will not allow any other communication with the user's terminal than sending and receiving messages carried in EAP packets, or in other packets related to the procedure of logging in to the broadband access network such as for accessing operator shop 1 or 2, such packets being e.g. PPPoE packets, see L. Mamakos et al., “A Method for Transmitting PPP Over Ethernet (PPPoE)”, RFC 2516, February 1999, in the case where another authentication method than EAP over IEEE 802.1x is used. Any Ethernet frame sent from the user's terminal will trigger the local VRF to initiate an EAP authentication procedure towards the terminal, in accordance with the standard document IEEE 802.1x.

During the EAP procedure the local VRF relays the EAP packets to the AAA client of the BRAS, which forwards them to the AAA proxy server of the BRAS. The AAA proxy server examines the realm part of the NAI that the user supplies in an EAP-Identity-Response message in order to determine what to do with the EAP procedure, i.e. to determine the AAA server to which it is to be directed or if it is to be handled it internally, in the case where the user wants access only to the local service VLAN. A home realm is the administrative domain with which the user maintains an account relationship and a local realm is the administrative domain providing services to a user. An administrative domain may act as a local realm for certain users, while being a home realm for others. The network access identifier (NAI) is used in the Diameter protocol to extract a user's identity and realm. The identity is used to identify the user during authentication and/or authorization, while the realm is used for message routing purposes. The string in the NAI that immediately follows the ‘@’ character is the realm part. NAI realm names are required to be unique. Diameter makes use of the realm, also loosely referred to as domain, to determine whether messages can be satisfied locally, or whether they must be routed or redirected. In this case the user accesses his home access network and the realm part of the NAI indicates either operator shop 1 or operator shop 2, e.g. “happy-user@op-shop1”. The AAA proxy server will then relay the AAA packets between the AAA client and the AAA server of the operator shop indicated by the NAI, operator shop 1 in this example. Hence, operator shop 1 has been selected.

After a successful authentication the BRAS instructs the concerned AN, e.g. via the simple network management protocol (SNMP), see D. Harrington et al., “An Architecture for Describing Simple Network Management Protocol (SNMP) Management Frameworks”, RFC 3411, December 2002, or some other protocol that the BRAS can use to control ANs, to associate the concerned RG port VLAN with VLAN 1 instead of the local default VLAN. Then the user can proceed to acquire an IP address using DHCP to enable subsequent IP communication. In order for the BRAS to know which AN to instruct, a virtual MAC must be used. The EAP procedure in itself does not give the BRAS any information about which AN that is being involved. Furthermore, the Ethernet network infrastructure between the AN and the BRAS does not allow the BRAS to trace where a certain frame came from. And the (original) source MAC address of the user carries no location or topology information. Thus, in order for the BRAS to know which AN to instruct, the AN must replace the original source MAC address of the user with a virtual MAC address that points out the responsible AN. To ensure that the BRAS can tell to which AN a virtual MAC address belongs, the different ANs are allocated different parts of the virtual MAC address range.

The AAA client can instead be located in the AN, and then neither the local default VLAN nor the virtual MAC are needed for this purpose.

If access only to the local service network is desired, the user could supply a special NAI, with a realm part belonging to the broadband access network, dedicated for this purpose. The AN could then keep its association between the concerned RG port VLAN and the local default VLAN.

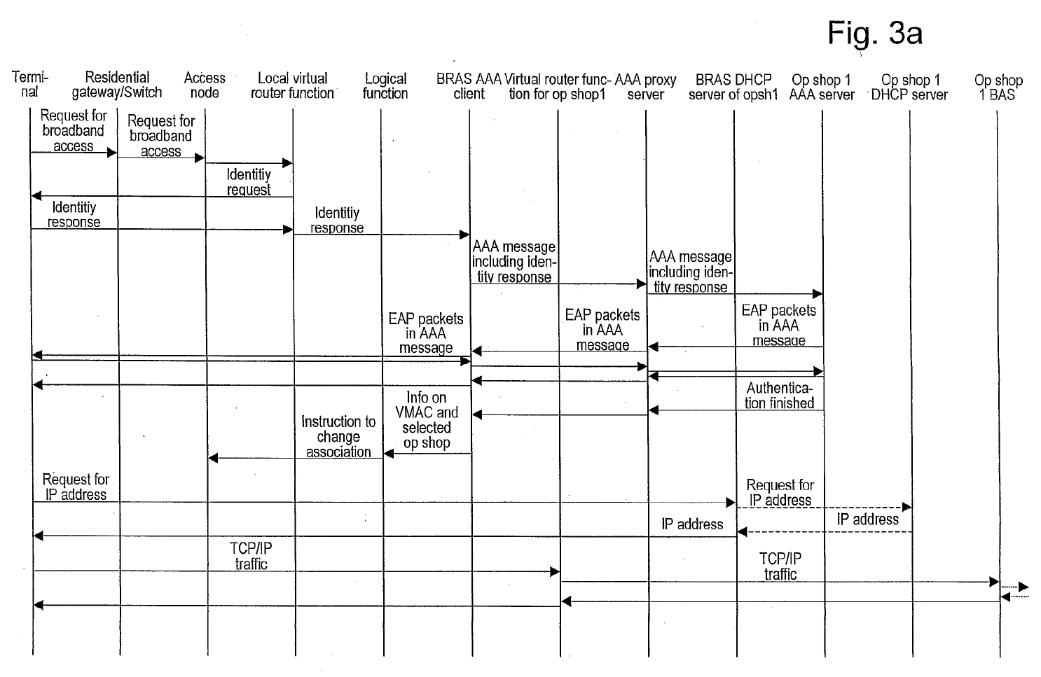

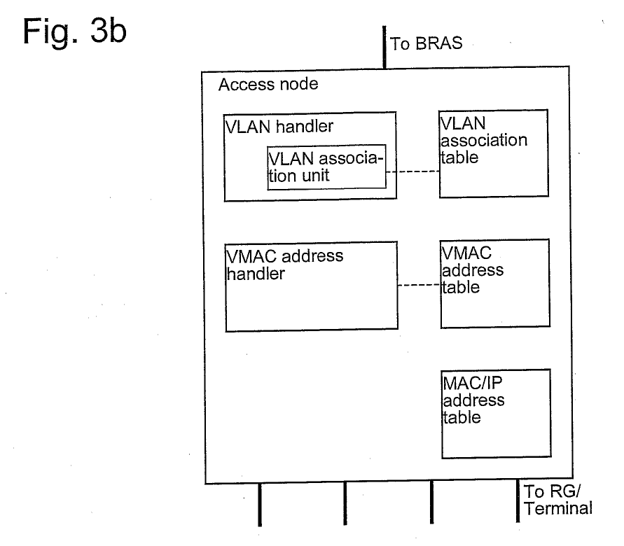

The different steps in accessing an operator shop are summarized below with reference to the signal diagram of FIG. 3. The user is assumed to be logged in to a CPN on a terminal having an MAC address and in particular connected to a specific port of the RG, the user identified by also this port.

1. User request to connect to broadband network, broadband access network or broadband network services, e.g. by simply turning on his terminal device while being connected to an RG port. Then, the terminals sends an EAPOL-Start-packet to the multicast address of “Port Access Entity” (PAE), called the “PAE group address” in the IEEE 802.1x specification, this specification defining PAE as the unit handling the authentication procedure towards the terminal and containing the “EAP Authenticator”. The EAP Authenticator is defined as the unit communicating with the terminal in an EAP-procedure. The PAE maintains a list defining the frames allowed to pass, other frames being blocking because the respective user is not authenticated. If the terminal sends a frame containing anything else than an EAPOL-Start packet, the EAP Authenticator/PAE/local VRF will intercept the frame and initiate an EAP procedure towards the terminal by sending an EAP-Identity-Request packet.
2. Frames of request received in AN and retagged to be transmitted into local default VLAN, also a VMAC address being introduced in frames, the VMAC address identifying the terminal and the AN. The assigned VMAC address primarily identifies the terminal, but by allocating different ranges of the virtual MAC address range to different ANs, it also identifies the AN.
3. Retagged frames of request or other frames from the user received in local VRF of BRAS. An EAPOL-Start packet is specifically received by the EAP Authenticator, i.e. the PAE, in or connected to the local VRF. If a frame including an unauthorized MAC address is received, a new user is detected, the frame is intercepted and given to be processed by the EAP Authenticator.
4. The EAP Authenticator in the local VRF sends an EAP-Identity-Request to the terminal.
5. The terminal responds with an EAP-Identity-Response, including the user's identity in the form of an NAI.
6. The EAP Authenticator passes the EAP-Identity-Response to the AAA client function located internally in the BRAS.
7. The AAA client includes the EAP-Identity-Response in a AAA message and sends the AAA message to the AAA proxy server, which may be part of the BRAS or co-located with the BRAS.
8. The AAA proxy server recognizes that operator shop 1 is wanted from the realm part of the NAI as supplied by the user in the EAP-Identity-Response packet and in the User-Name attribute in the AAA message. The AAA proxy server thus can find the NAI in the User-Name attribute, but theoretically it could also extract it from the EAP-Identity-Request that is encapsulated in the AAA message. In addition, Diameter clients, i.e. AAA clients using the Diameter protocol, also insert the realm part of the NAI in the Destination-Realm attribute, which the AAA proxy server then can use to identify the operator shop. The AAA proxy server transmits the AAA request to AAA server in operator shop 1.
9. EAP authentication procedure between AAA server in operator shop 1 and user terminal through the AAA proxy and AAA client of BRAS. The EAP procedure is handled end-to-end between the terminal and the authentication server which is the AAA server. Between the AAA client and the AAA server the EAP packets are encapsulated in AAA messages.
10. The BRAS includes a logical function (LU) obtaining information that the AAA procedure has been completed and which operator shop has been selected. This is done by the AAA server informing the AAA client, through an AAA message, after the authentication procedure has been (successfully) finalized, the AAA client in turn informing said logical function, and since the AAA proxy is also informed through the same AAA message, the AAA proxy can also be the one informing said logical function. The logical function instructs the AN to change association between VLANs, using the VMAC address of the terminal to find the correct AN. The VMAC address is a unique, locally in the broadband access network, locally administered MAC address assigned to the terminal. Hence it “belongs to” and identifies the terminal, although the terminal itself never sees the VMAC address or even are aware of its existence. But by allocating different parts of the VMAC address range to different ANs, the VMAC can also be used to identify the AN that assigned it to the terminal. The information on the selected operator is obviously available inside the BRAS and the above procedure can be performed in various ways, such as:
a) When the AAA proxy server identifies the selected operator shop, it notifies some other part of the BRAS, e.g. the LU, of the selection and which VMAC address it concerns, the latter case requiring that the AAA client includes the VMAC address in the AAA message). The LU may receive the operator shop selection information in the form of the realm part of the NAI or some other BRAS internal identifier to which the AAA proxy has translated the realm part. Then the LU only has to wait for a notification of a successful user authentication before instructing the AN to associate certain VLANs.
b) The AAA client or the EAP Authenticator passes the realm part of the NAI and the VMAC address to some other part of the BRAS, e.g. the LU, even before transmitting the first AAA message to the AAA proxy. The LU then only has to wait for an indication of a successful user authentication.
c) When the AAA client receives from the AAA server, via the AAA proxy server, the AAA message including the indication of a successful user authentication, it informs some other part of the BRAS, e.g. the LU, of the VMAC address and the selected operator shop, in the form of the realm part of the NAI. The LU may then, if needed or desired, translate the realm part of the NAI to some BRAS internal identifier, e.g. a VLAN ID.
d) When the AAA proxy server receives, from the AAA server, the AAA message including the indication of a successful user authentication, it informs e.g. the LU of the VMAC address, which requires that the AAA client has previously included the VMAC address in a AAA message, and the selected operator shop associated with this VMAC address. The selected operator shop can then be indicated as a FQDN, i.e. the realm part of the NAI, or as a BRAS internal identifier identifying the operator shop. The AAA proxy should of course also forward the AAA message to the AAA client.
11. The AN receives instruction message such as “Associate the RG port VLAN of VMAC X with VLAN 1”, where the VMAC allocated to the terminal is denoted by “X”, the RG port VLAN is the VLAN of the RG port to which the terminal identified by VMAC X is connected and it is assumed that the user wants access to operator shop 1. The AN accordingly changes tagging for VLANs so that frames from the concerned RG port VLAN are tagged for VLAN 1 instead of being tagged for the local default VLAN, such as by the AN changing a record in a VLAN association table or generally some data structure that the AN uses to keep track of associations between VLANs. Such a data structure can be implemented in a variety of ways.
12. When the user is authenticated, the terminal can proceed to acquire an IP address. This will be an IP address from the address range of operator shop 1. This is supplied by a DHCP server in operator shop 1, e.g. located in the BAS. A DHCP server in the BRAS will act as DHCP relay agent in this procedure. In this case the DHCP server acting as DHCP relay agent is associated with the VRF 1 for operator shop 1. Alternatively the DHCP server in the BRAS can allocate IP addresses directly to the terminal from the address range of operator shop 1. This requires that the DHCP server in the BRAS has been given a pool of addresses out of the address range of operator shop 1.
13. After the terminal has been given an IP address, the user can start traffic using TCP/IP, through VLAN 1, VRF 1 and the BAS of operator shop 1. For example, he can receive a web page of the BAS of operator shop 1. Such a web page can present services that can be accessed through operator shop 1. This can be achieved by e.g. the user's browser having the web page of the selected operator shop set as its start page, such as configured manually by the user according to instructions from the operator shop when the subscription to this operator shop was agreed on.

AN Modules/Components:

VLAN handler, including submodule for receiving instruction of changed association and for changing association accordingly

VLAN association table, se example below

VMAC address handler

VMAC address table

MAC address to IP address table

TABLE 1
VLAN association table for N different RG ports

| VLAN at the customer premises side | VLAN at the network side |
|---|---|
| RG port VLAN 1 | VLAN 1 |
| RG port VLAN 2 | VLAN 1 |
| RG port VLAN 3 | Local default VLAN |
| RG port VLAN 4 | VLAN 2 |
| . | . |
| . | . |
| . | . |
| RG port VLAN N | VLAN 1 |

BRAS Modules/Components:

BRAS network including connection to/including BRAS local service network

Local VRF connected in BRAS network

AAA client directly connected to local VRF and to AAA proxy server

AAA proxy server connected in BRAS network and to AAA servers in operator shops 1 and 2

VRF 1 connected in BRAS network for routing traffic only to/from operator shop 1 except for certain special cases when traffic can be routed differently. VRF 1 functions as the access router of operator shop 1 in the broadband access network. From the point of view of operator shop 1, VRF 1 appears as part of the own network of operator shop 1.

VRF 2 connected in BRAS network for routing traffic only to/from operator shop 2 except for certain special cases when traffic can be routed differently.

Association instruction unit or logical function unit LU for monitoring AAA procedure and for instructing ANs to change associations between VLANs.

DHCP server for operator shop 1.

DHCP server for operator shop 2.

Access Through a WLAN AP Supporting the Virtual AP Concept

It can first be assumed that the WLAN AP supports the virtual AP (vAP) concept, i.e. that it has the capability or includes the function of emulating multiple logical APs in a single physical AP. In such a case each operator shop connected to the broadband access network is also assumed to have “its own” logical AP with a dedicated SSID being broadcast in beacon messages from the AP. Furthermore, the WLAN AP associates each operator shop SSID with the VLAN dedicated for the respective operator shop, such that all traffic, from authenticated users, pertaining to a certain SSID is passed to the associated VLAN and vice versa. The WLAN AP also has a logical AP and a SSID associated with the local WLAN AP VLAN, which allows a user access to the local service network. In FIG. 2a the SSIDs for the operator shops 1 and 2 are denoted by “SSID 1” and “SSID 2”, respectively, and the SSID for the local WLAN AP VLAN is denoted by “SSID local”.

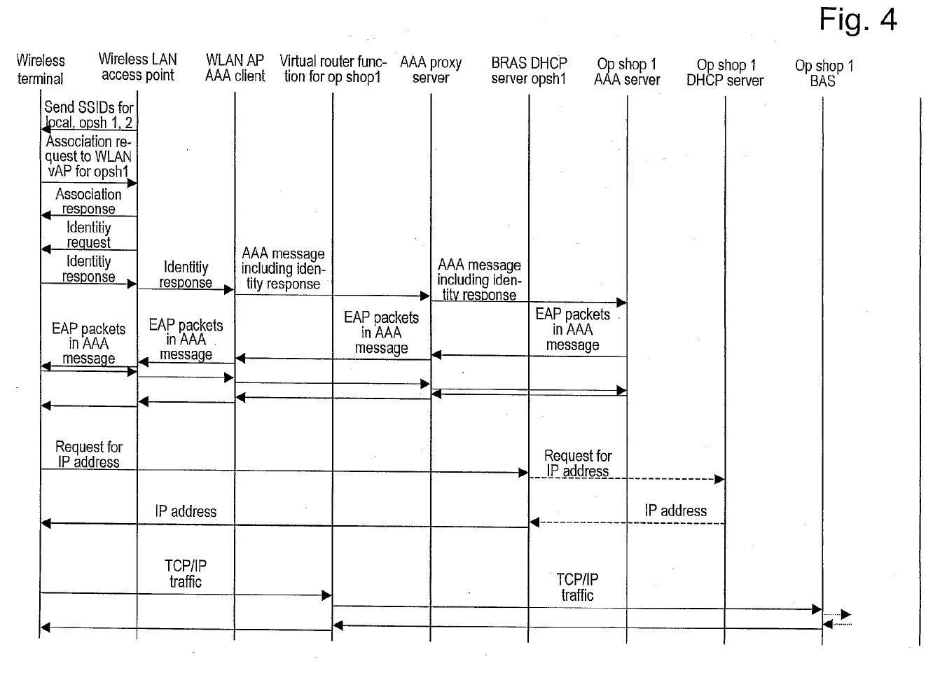

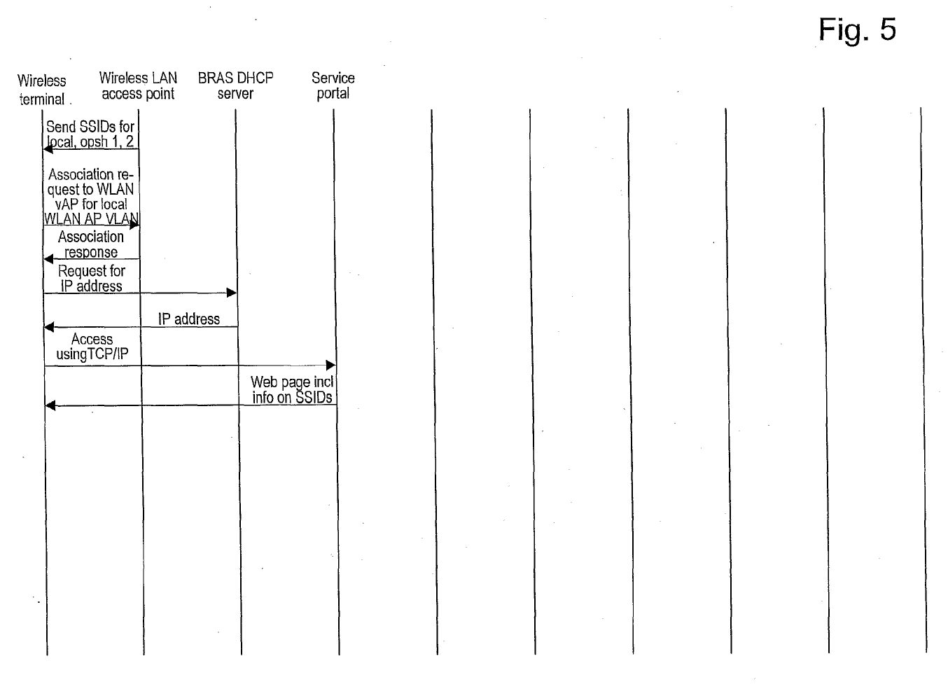

When accessing the broadband network through a WLAN AP supporting the virtual AP concept, the user must select the SSID associated with his home operator shop, this being one of operator shops), see FIG. 4, or the SSID associated with the local WLAN AP VLAN for delivery of publicly available services, see FIG. 5. The SSID should preferably be a string that is easily interpreted by human beings, e.g. the name of the operator shop or its realm-FQDN (Fully Qualified Domain Name). Then the terminal can scan for broadcast SSIDs and present the result to the user, who can manually select the one belonging to his home operator shop. It is also possible to configure the terminal to search for and attach to (i.e. associate with) a certain SSID.

If the SSID information is not enough for the user to select an operator shop, i.e. to select one of the SSIDs, he may attach to (i.e. associate with) the SSID associated with the local WLAN AP VLAN and obtain more information, about available operator shops and their associated SSIDs, from the service portal before manually selecting one of the SSIDs associated with operator shops, see FIG. 5. In the local WLAN AP VLAN the user is allowed access and can acquire an IP address without a prior user authentication.

When the user attaches to the WLAN AP using the selected SSID the AAA request resulting from the EAP authentication procedure is routed, via the BRAS AAA proxy server, to the operator shop that is associated with the SSID, irrespective of what NAI the terminal supplies. If the NAI does not indicate the operator shop associated with the selected SSID in the realm part, the WLAN AP can either reject the access request or force the AAA request to be routed to the operator shop associated with the selected SSID. To force the AAA request to be routed to the operator shop associated with the selected SSID, despite another realm indicated in the NAI, the WLAN AP can either modify the received NAI into an extended format that includes an intermediate network realm or include the selected SSID in a vendor specific AAA attribute, such as using some suitable protocol extension. If the SSID is passed to the AAA proxy server in an AAA attribute, the AAA proxy server would use the SSID, instead of the realm part of the NAI, to direct the AAA message to the AAA server of the selected operator shop. In the extended NAI method the extended NAI has the general format “home-realm/name@intermediate-realm” or “home-realm!name@intermediate-realm”, where “home-realm” is the realm of the home network/home operator shop, “intermediate-realm” is the realm of a selected intermediate network/intermediate operator shop and “name” is the user's username. A field or name separator “/” or “!” is used to differentiate between the “extra” realm which in this case is the original realm, and the user name. Such extended NA1s are already used by the WLAN roaming broker iPass and it is planned to be used in the 3GPP-WLAN interworking. In this specific case the format of the extended NAI, into which the WLAN AP may modify the received NAI, would be “realm-supplied-in-NAI/name@op-shop-realm-associated-with-selected-SSID” or “realm-supplied-in-NAI!name@op-shop-realm-associated-with-selected-SSID”.

Thus, it has been described how the AAA routing can be modified to ensure that it routes according to the selected SSID, even if the user has supplied a NAI that does not indicate the operator shop associated with the selected SSID, where the SSID selection has precedence over the NAT in this case. Two ways are described: one way is to base the AAA routing explicitly on the selected SSID, which requires that the SSID is being included in an AAA attribute, and the other way is to modify the NAI in a way that makes the AAA routing direct the AAA messages to the correct operator shop, i.e. the one associated with the selected SSID. The user may e.g. erroneously supply a NAI that does not belong to the operator shop of the selected SSID, such as by a mistake made during SSID selection or during manual NAI entering. In any case it is ensured that access using the virtual AP, with its associated SSID, of one operator shop is not handled by the AAA server of another operator shop.

Following a successful user authentication the user can proceed to acquire an IP address via DHCP to enable subsequent IP communication.

The different steps in accessing an operator shop in the case where the user chooses access to a WLAN virtual AP associated with an operator shop are summarized below with reference to the signal diagram of FIG. 4.

1. WLAN AP is transmitting SSIDs for a plurality of VLANs connected in BRAS.
2. Terminal transmits a request for “associating” with the WLAN virtual AP for a selected SSID among those associated with operator shops 1 and 2.
3. The selected WLAN virtual AP transmits an association response to terminal.
4. The WLAN virtual AP transmits, thereby starting EAP procedure, from its EAP Authenticator an EAP-Identity-Request to the terminal.
5. The terminal responds with an EAP-Identity-Response, including the user's identity in the form of an NAI.
6. The EAP Authenticator passes the EAP-Identity-Response to the AAA client function of the WLAN AP.
7. AAA client function in WLAN AP transmits AAA request, including the NAI supplied by the user in the response and the SSID of the virtual AP, to AAA proxy server in BRAS.
8. AAA proxy server recognizes, from the SSID that is included in the AAA request, that operator shop 1 is wanted and transmits AAA request to AAA server in operator shop 1.
9. EAP authentication procedure between AAA server in operator shop 1 and user terminal through the AAA proxy server of the BRAS and AAA client of WLAN AP. The EAP procedure is handled end-to-end between the terminal and the authentication server which is the AAA server. Between the AAA client and the AAA server the EAP packets are encapsulated in AAA messages.
10. The WLAN AP is informed that the authentication is successfully completed, through an AAA message which goes all the way to the AAA client in the WLAN AP. The WLAN AP then allows frames from and to the concerned terminal to be forwarded. The selected SSID already indicates the destination to which VLAN the uplink frames should be forwarded. No VMAC address is needed. Source integrity protection using the mechanisms of IEEE 802.11i ensures that no other terminal can use the same MAC address for communication through the WLAN AP.
11. The WLAN AP starts forwarding frames from and to terminal using VLAN 1 by tagging frames accordingly.
12. When the user is authenticated, the terminal can proceed to acquire an IP address. This will be an IP address from the address range of operator shop 1. It is supplied by a DHCP server in operator shop 1, e.g. located in the BAS. A DHCP server in the BRAS will act as DHCP relay agent in this procedure. In this case the DHCP server acting as DHCP relay agent is associated with the VRF 1 for operator shop 1. Alternatively, a DHCP server in the BRAS can allocate the IP address out of the address range of operator shop 1 without involving a DHCP server in operator shop 1. In that case the BRAS DHCP server has to have been given a dedicated pool of IP addresses out of the address range of operator shop 1.
13. After the terminal has been given an IP address, the user can start traffic using TCP/IP, through VLAN 1, VRF 1 and the BAS of operator shop 1. For example, he can receive a web page of the BAS of operator shop 1. Such a web page can present services that can be accessed through operator shop 1.

WLAN AP modules/components/functions:

Local virtual AP function

Virtual AP function for operator shop 1

Virtual AP function for operator shop 2

SSID-VLAN association list

AAA client

BRAS Modules/Components:

BRAS network including connection to/including BRAS local service network

Local VRF connected in BRAS network

AAA client directly connected to local VRF and to AAA proxy server

AAA proxy server connected in BRAS network and to AAA servers in operator shops 1 and 2

VRF 1 connected in BRAS network for routing traffic only to/from operator shop 1, except for certain special cases when traffic can be routed differently. VRF 1 functions as the access router of operator shop 1 in the broadband access network. From the point of view of operator shop 1, VRF 1 appears as part of the own network of operator shop 1.

VRF 2 connected in BRAS network or routing traffic only to/from operator shop 2, except for certain special cases when traffic can be routed differently.

DHCP server for operator shop 1.

DHCP server for operator shop 2.

The different steps in accessing an operator shop in the case where the user chooses access to a WLAN virtual AP associated with the local WLAN AP VLAN are summarized below with reference to the signal diagram of FIG. 5.

1. WLAN AP is transmitting SSIDs for a plurality of VLANs connected in BRAS.
2. Terminal transmits a request for “associating” with the WLAN virtual AP for the SSID associated with the local WLAN AP VLAN.
3. The selected WLAN virtual AP transmits an association response to the terminal.
4. The terminal proceeds to acquire an IP address, the WLAN AP forwarding frames between the terminal and the local WLAN AP VLAN. The IP address is acquired from a DHCP server in the BRAS.
5. After the terminal has acquired an IP address, it accesses the service portal, via the local VRF. If the user tries to access some other web server, he may be redirected to the service portal anyway through the HTTP redirect function.
6. The service portal transmits information about available operator shops and their associated SSIDs to the terminal to be read by the user.
7. The user disassociates from the WLAN virtual AP for local services. The user then manually selects a new SSID, this time one that is associated with an operator shop, and then the same steps are used as described above when the user chooses access to a WLAN virtual AP associated with an operator shop. Thus, in this case the information at the service portal is used in a very rudimentary way: the user reads the information and uses it for manual SSID selection. There is no automation in this reselection.

The required WLAN AP modules/components/functions are the same as in the first case but the BRAS modules/components have to also include a service portal connected in BRAS network.

Access Through a WLAN AP not Supporting the Virtual AP Concept

If the WLAN AP does not support the virtual AP concept and can only present a single SSID to possible users, the solution is somewhat similar to the procedure used for access through a CPN. In this case an AN is used that is connected between the WLAN AP and the BRAS, see FIG. 2b. Furthermore, the VLANs illustrated in FIG. 2a that extend all the way to the WLAN AP, i.e. VLAN 1, VLAN 2 and the local WLAN AP VLAN, do not have to encompass the link between the AN and the WLAN AP, but instead end in the AN as illustrated in FIG. 2b. No VLAN separation is needed between the WLAN AP and the AN. VLAN separations means that different parts of the traffic are separated from each other using VLAN tagging, but physically the traffic is mixed. Only logically the traffic is treated as belonging to different virtual LANs.

The WLAN AP is assumed to continuously broadcast an SSID belonging to or representing itself and hence also, basically, for accessing the local service network. The terminal receives the SSID and the user selects to attach to the WLAN AP. When the user attaches to the WLAN AP, the AAA request resulting from the EAP authentication procedure is routed to the BRAS AAA proxy server, that determines from the realm part of the NAI, which should indicate either the realm of operator shop 1 or the realm of operator shop 2, whether to route the request to operator shop 1 or to operator shop 2. The AAA client of the WLAN AP includes the MAC address of the terminal in an AAA attribute in the AAA request.

During, or immediately following, the authentication procedure the operator shop AAA server provides one or more session keys, possibly produced as a by-product of the authentication procedure, to the WLAN AP to be used for the cryptographic protection mechanisms of the proposed standard IEEE 802.11i. The mechanisms of the proposed standard IEEE 802.11i crypto-graphically ties the MAC address of the terminal that the user is currently using to the authenticated user for this particular session.

Following a successful user authentication the BRAS instructs the AN, e.g. via SNMP or some other protocol that the BRAS can use to control ANs, to associate the user's current MAC address with the service VLAN of the selected operator shop, e.g. VLAN 1 if operator shop 1 was selected. Then the terminal can proceed to acquire an IP address via DHCP to enable subsequent IP communication.

Before associating the user's current MAC address with a VLAN, the AN preferably sends packets received from the WLAN AP with the user's MAC address as the source address to the local WLAN AP VLAN that provides access to the local service network, or alternatively, it can discard such packets. The user may have indicated, at the start of the EAP procedure that access only to the local service network is desired by supplying a special NAI, including a realm part belonging to the broadband access network, dedicated for this purpose, and the AN could keep sending, or alternatively be instructed to do so, packets received from the WLAN AP with the user's MAC address as the source address to the local WLAN AP VLAN. Observe that for access solely to the local service network via the local WLAN AP VLAN no authentication is needed and no IEEE 802.11i protection procedure would be used over the radio interface.

This procedure only requires a standard behaviour of the WLAN AP and can thus be used with available off-the-shelf APs.

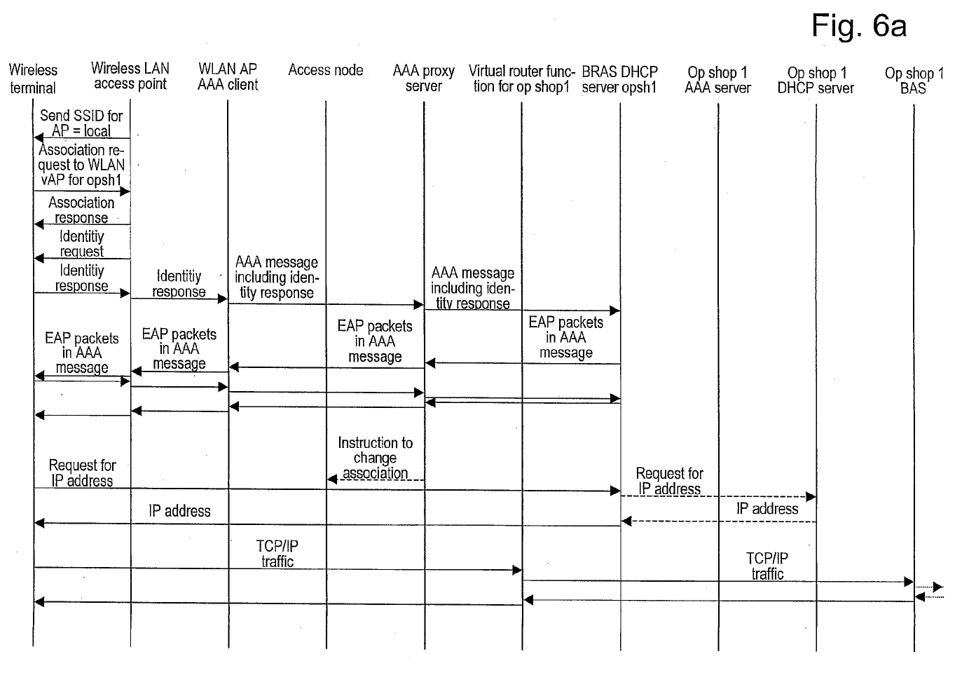

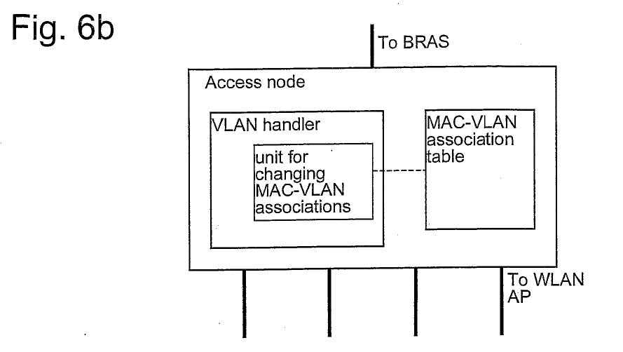

The different steps in accessing an operator shop in the case where the WLAN AP does not support WLAN virtual APs are summarized below with reference to the signal diagram of FIG. 6a.

1. WLAN AP is transmitting only its own SSID, denoted “SSID local” in FIGS. 2b and 6a.
2. Terminal transmits a request for “associating” with the WLAN AP.
3. The WLAN AP transmits an association response to the terminal.
4. The WLAN AP transmits, thereby initiating EAP procedure, from its EAP Authenticator an EAP-Identity-Request to the terminal.
5. The terminal responds with an EAP-Identity-Response, including the user's identity in the form of an NAI.
6. The EAP Authenticator passes the EAP-Identity-Response to the AAA client function of the WLAN AP.
7. The AAA client in the WLAN AP encapsulates the EAP packet with the NAI in a AAA message, including also the MAC address of the terminal in the same AAA message, and sends the AAA message to the AAA proxy server in the BRAS.
8. The AAA proxy server looks at the realm part of the NAI and determines to which AAA server the AAA message is to be forwarded, in this case operator shop 1. AAA proxy server transmits AAA request to AAA server in operator shop 1. The AAA proxy server also retrieves the MAC address of the terminal from the AAA message and stores it in the BRAS for future use. This future use is the instructions that will be sent to the AN following a successful authentication.
9. The EAP authentication procedure is executed between the user terminal and the AAA server in the selected operator shop, i.e. the one indicated by the realm part of the NAI (in this case operator shop 1), through the AAA proxy server and AAA client of WLAN AP.
10. After the user has been successfully authenticated the AAA server sends an AAA message indicating the successful authentication.
11. This message is received by the AAA proxy server and relayed to the AAA client in the WLAN AP, as is a standard AAA procedure. Thus, both the BRAS and the WLAN AP are aware of the successful authentication. The AAA server also sends, e.g. in the same message as the success indication, one or more keys to the WLAN AP to be used for cryptographic protection of the traffic between the WLAN AP and the terminal.
12. Then the BRAS instructs the AN to associate the MAC address of the terminal with the VLAN of the selected operator shop (in this case VLAN 1 which is associated with operator shop 1). Since the MAC address is cryptographically tied to the authenticated user through the IEEE 802.11i mechanisms, this association is all that is needed and safe against MAC address spoofing. No VMAC address is needed in this case. Since the AAA client in the WLAN AP is used, the BRAS already knows which WLAN AP the terminal is accessing and thus which AN to instruct.
13. WLAN AP starts forwarding frames from and to terminal.
14. The AN starts forwarding frames pertaining to the concerned terminal. This means forwarding uplink frames with the MAC address of the terminal as the source address to VLAN 1 and forwarding downlink frames with the terminal's MAC address as the destination address from VLAN 1 to the WLAN AP.
15. After the user has been authenticated, the terminal can proceed to acquire an IP address, in this case an IP address from the address range of operator shop 1. This is supplied by a DHCP server in operator shop 1, e.g. located in the BAS. A DHCP server in the BRAS will act as DHCP relay agent in this procedure. In this case the DHCP server acting as DHCP relay agent is associated with the VRF 1 for operator shop 1. Alternatively, a DHCP server in the BRAS can allocate the IP address out of the address range of operator shop 1 without involving a DHCP server in operator shop 1. In that case the BRAS DHCP server has to have been given a dedicated pool of IP addresses out of the address range of operator shop 1.
16. After the terminal has been given an IP address, the user can start traffic using TCP/IP, through VLAN 1, VRF 1 and the BAS of operator shop 1. For example, he can receive a web page of the BAS of operator shop 1. Such a web page can present services that can be accessed through operator shop 1.

AN Modules/Components, see FIG. 6b:

VLAN handler, including submodule for receiving instructions of VLAN to be used for traffic with terminal, for changing association list and for tagging frames accordingly

MAC-VLAN association list

BRAS Modules/Components:

BRAS network including connection to/including BRAS local service network.

Local VRF connected in BRAS network.

AAA proxy server connected in BRAS network and to AAA servers in operator shops 1 and 2.

VRF 1 connected in BRAS network for routing traffic only to/from operator shop 1, except for certain special cases when traffic can be routed differently.

VRF 2 connected in BRAS network for routing traffic only to/from operator shop 2, except for certain special cases when traffic can be routed differently.

Association instruction unit or logical function unit LU for monitoring AAA procedure and for instructing ANs to direct frames to specified VLAN.

DHCP server for operator shop 1.

DHCP server for operator shop 2.

A layer 3 procedure, based on IPsec tunnels as is described hereinafter, can also be used by a user/terminal accessing the broadband access network through a WLAN AP.

Access Through an IPsec Tunnel

A layer 3 procedure based on an IPsec tunnel between the terminal and a node in the broadband access network, as will now be described, can be seen as either a supplement to or a replacement of the layer 2 procedures described above.

The layer 2 procedures cannot be used in those cases where a plurality of users connect through the same general RG port, e.g. through a WLAN AP connected to or integrated with the RG or when there is no separate RG port available. In addition, the user may have a router with an NAT connected to the RG, so that several devices/users can connect to the NAT using the same IP address allocated from the network, see FIG. 2c. Such a home based NAT, which is quite common, makes a layer 2 solution even less feasible. Thus, in these cases the layer 3 procedure is required. However, the layer 3 access procedure is a general solution that can be used in all cases, whether the user connects through a CPN or a WLAN AP.

In a basic case it can be assumed that a roaming user connects through an RG port. This is a case where a layer 3 solution is needed: the user visits a friend, hence he is roaming, the friend's CPN being connected to a broadband access network that is connected to the user's home operator shop. Hence this is a case where the user is accessing his “home broadband access network”. There is no separate RG port available for the roaming user through which he can connect using a layer 2 procedure. Instead he uses an RG port which is already being used by his friend and which thus already is associated with a service VLAN, i.e. VLAN 1 or VLAN 2. Since all traffic via this RG port will pass through the associated service VLAN, due to the VLAN association in the AN, the user/terminal will have to establish the IPsec tunnel through this service VLAN, even though the IPsec tunnel may be used to associate the user/terminal with another operator shop, i.e. the roaming user's home operator shop, than that associated with the traversed service VLAN.

However, the user does not have to be roaming to use the IPsec tunnel procedure through a service VLAN. Another case is for instance a user having subscriptions with two different operator shops, e.g. operator shops A and B connected to the same broadband access network. In that case the user may have used the layer 2 procedure to associate an RG port with the service VLAN of operator shop A and then decides that he also wants to access some service in operator shop B. The user may then use the layer 3 procedure and establish an IPsec tunnel via the service VLAN of operator shop B. This case is however quite demanding for the operating system of the terminal, and possibly also for the applications running on the terminal, since the operating system has to be capable of handling multiple IP addresses and the applications may have to deal with source address selection.

It is also possible to establish the IPsec tunnel via an RG port that is associated with the local default VLAN, or via a WLAN AP and one of the service VLANs or via a WLAN AP and the local WLAN AP VLAN, but the case where the IPsec tunnel is established via a service VLAN is of greater interest, even though the mechanisms are the same.

Since the user is accessing the broadband access network through another user's CPN, he is roaming. This should be distinguished from roaming to a foreign broadband access network, i.e. to a broadband access network that has no connection to the user's home operator shop, the latter case described in particular sections below.

Thus, the cases considered here deal with a user accessing his “home broadband access network”, this defined here as a broadband access network that has a connection to the user's home operator shop. Hence, a roaming user is assumed to connect through an RG port which is already associated with an authenticated connection towards one of the operator shops, i.e. from the user terminal an IPsec tunnel is in the connection operation being established through the RG port to one of the service VLANs, i.e. VLAN 1 or VLAN 2. However, it is also possible to establish the IPsec tunnel through an RG port that is associated with the local default VLAN, or via a WLAN AP and a service VLAN or the local WLAN AP VLAN. When the IPsec tunnel is established through the local default VLAN, it passes an RG, an AN, the local default VLAN and the local VRF. When the IPsec tunnel is established through a WLAN AP and a service VLAN, it passes a WLAN AP, possibly an AN, depending on whether an AN is used for the WLAN AP case, a service VLAN and the VRF associated with the service VLAN. When the IPsec tunnel is established through a WLAN AP and the local WLAN AP VLAN, it passes a WLAN AP, possibly an AN, depending on whether an AN is used for the WLAN AP case, the local WLAN AP VLAN and the local VRF. The tunnel end points are the same in all three cases, i.e. in the local VRF, or possibly a dedicated tunnel endpoint/termination device, in a dedicated VRF or in the BAS, as will be discussed hereinafter.

The most straightforward layer 3 procedure is that the IPsec tunnel is established between the terminal and the BAS in the concerned operator shop. That procedure is one of the alternatives that will be described hereinafter, but it does suffer from a number of deficiencies:

The IPsec tunnel to an operator shop is established via another operator shop. In the case of FIG. 2a the IPsec tunnel can extend from the terminal via the RG, the AN, VRF 1 and operator shop 1 and then across the Internet to the BAS of operator shop 2. However, this procedure is suboptimal, both from charging and routing points of view, since the packets of the IPsec tunnel are not given any special treatment. These packets, just like any packets sent through an RG port associated with operator shop 1, are forwarded by VRF 1 to operator shop 1 and then find their way to the BAS of operator shop 2 across the Internet. Thus, the “another operator shop”, via which the IPsec tunnel is undesirably established, is the operator shop with which the concerned RG port is associated. This problem can be avoided by instead extracting the IPsec tunnel and routing it internally in the broadband access network. This means that the packets constituting the IPsec tunnel and the packets that are used to establish the IPsec tunnel are specially treated, so that these packets are not routed through the operator shop associated with the VRF, i.e. operator shop 1 in the above example, but instead finds their way to the destination BAS, i.e. the BAS of operator shop 2 in the above example, through the BRAS and the VRF dedicated for the destination operator shop, VRF 2 in the above example. In practice, and in this example, this means that VRF 1 must have an entry in its routing table for each IP address—there may be one or multiple ones for each BAS—that is used for IPsec tunnel endpoints in the BAS of operator shop 2. This routing table entry should point towards VRF 2. The result is that VRF 1 will send packets addressed to a “tunnel endpoint address” of the BAS of operator shop 2 to VRF 2 instead of operator shop 1. A routing table entry for a single IP address can also be called a “host route”. The term “routing it internally” means in particular that the packets of the IPsec tunnel, as well as the packets that are used to establish the IPsec tunnel, are routed in the BRAS, as described above from one VRF through the BRAS to another VRF and then further to the operator shop that is the endpoint of the tunnel.

However, if multiple operator shops connected to a broadband access network use overlapping address spaces, which is a case that must be supported, e.g. address spaces including private addresses, such a procedure does not work, unless the tunnel endpoint at the operator shop is a globally unique address, i.e. not from any overlapping address range. A private IP address is an address from a dedicated range of addresses, assigned by the IANA (Internet Assigned Numbers Authority), that can be used in networks that are “address-wise” isolated from the global Internet. These addresses can be reused in different networks and are not globally unique. When connecting a network that uses private IP addresses to the global Internet, the gateway between the private network and the Internet has to be a NAT. The basic operation of a NAT is to dynamically associate, i.e. “translate”, a pair consisting of a private IP address and a TCP or UDP port on the private network side with a global IP address and a TCP or UDP port on the Internet side. These associations are dynamically established, and also deleted, on a per TCP/UDP connection basis. This way multiple devices, using private IP addresses, can share a single globally unique IP address in the NAT. However, all applications cannot work across NATs.

It makes informing the user/terminal about the address of the remote tunnel endpoint more difficult because:

There is a different endpoint for each connected operator shop.

The remote endpoint address is administered by an organization different from that of the broadband access network.

The AAA entities of the broadband access network, i.e. the AAA client and the AAA proxy server in the BRAS, are not involved in the AAA procedures, which may create issues associated with accounting.

The above disadvantages imply that it is preferable to confine the layer 3 access procedure to the broadband access network.

Locating the remote tunnel endpoint in the BRAS is a way of confining the layer 3 access procedure to the broadband access network. It is still, however, possible to provide a different endpoint for each operator shop or a single common endpoint for all operator shops. The former alternative, i.e. having different tunnel endpoints, provides a simpler operator shop selection mechanism, but it makes informing the user or terminal about endpoint addresses more complicated. The latter alternative, i.e. having a common endpoint, has the advantage that the same tunnel endpoint address can be used for all operator shops, but as a consequence the selection mechanism becomes more complex, at least in the case when a foreign broadband access network is accessed, because it cannot be based on the tunnel endpoint.

Thus, these different variants of accessing methods using layer 3 have their respective advantages and disadvantages. They will now be described in detail.

Access Through an IPsec Tunnel to a Common Tunnel Endpoint in the BRAS

In this procedure the single common tunnel endpoint address is located in the BRAS and belongs to the local VRF. It should however be pointed out that even though the description below uses the local VRF as the tunnel endpoint, a dedicated tunnel endpoint device, e.g. an IPsec tunnel endpoint server in the BRAS, can be used instead of the local VRF. Such a dedicated endpoint server would then also be connected in a BRAS internal network or the local service network.

As above, in the basic case it is assumed that a roaming user connects through an RG port which is already associated with an authenticated connection towards one of the operator shops, e.g. operator shop 1. The IPsec tunnel is established from the terminal to the local VRF via one of the other VRFs, e.g. VRF 1 in FIG. 2a assuming that the RG port through which the IPsec connection is being established is currently associated with VRF 1, see also FIG. 2d. The tunnel endpoint devices execute the IKEv2 procedure that is used to establish the IPsec tunnel, i.e. the terminal and the local VRF in this case. The IKEv2 messages are routed via another VRF. The local VRF has an IP address from the address range of the broadband access network and this indicates to VRF 1 that the packets should be routed to the local service network, or at least some BRAS-internal inter-VRF network, instead of being forwarded to operator shop 1. This is obvious from the routing table in VRF 1. In another case, the RG port through which the user is connecting can be currently associated with the local default VLAN and the local VRF, through the RG port VLAN and the AN, and then the IPsec tunnel will not traverse any of the other VRFs, but this case is of less interest.

The IPsec tunnel is established using IKEv2 (Internet Key Exchange protocol version 2) with the NAT traversal detection option and with EAP as an integrated authentication mechanism. When the terminal provides the user's regular NAI during the EAP authentication procedure, the local VRF examines the realm part of the NAI and identifies the home operator shop of the user, e.g. operator shop 2. The local VRF forwards the EAP packets to and from the AAA client in the BRAS and the AAA client communicates with the AAA server of operator shop 2 via the AAA proxy server.

After successful authentication the IPsec tunnel establishment proceeds and concludes and the local VRF associates the established tunnel interface with the route to VRF 2. In the VRF some data structure is used internally to associate a tunnel interface with a routing table entry, or some other internal mechanism, not involving the routing table. The data structure or mechanism can involve/use pointers, tables or similar devices. Then the local VRF, assisted by a DHCP server in the BRAS, assigns an “inner” IP address, taken from the address range of operator shop 1, to the terminal to be used for packets sent inside the IPsec tunnel, using the method described in B. Patel, B. Aboba, S. Kelly, V. Gupta, “Dynamic Host Configuration Protocol (DHCPv4) Configuration of IPsec Tunnel Mode”, RFC 3456, January 2003. Subsequently, all packets arriving to the local VRF through the tunnel will be routed to the VRF 2, optionally excluding packets addressed to the local service network.

VRF 2 and the local VRF must each also establish a host route for the assigned inner address, so that packets arriving from operator shop 2 destined for the concerned terminal are routed to the local VRF and to the tunnel endpoint. A “host route” is a route, or rather a routing table entry, for a single IP address.

The IPsec tunnel may also be established via the local default VLAN, or via a WLAN AP and a service VLAN, i.e. one of VLAN 1 and VLAN 2, or the local WLAN AP VLAN. If the IPsec tunnel is established via the local default VLAN or the local WLAN AP VLAN, it will not traverse any of the VRFs that are associated with operator shops.

To enable the terminal to establish the IPsec tunnel, it must be informed about the tunnel endpoint address that it is to use. This can be announced on the service portal, either as a FQDN or as an explicit IP address. The operating system of the terminal must have an IKEv2/IPsec protocol stack and some additional software to initiate the IKEv2 procedure, manually or from an application.

Another attractive possibility is to create a new DHCP option that indicates the tunnel endpoint either as an FQDN or as an explicit IP address, this requiring some changes in the DHCP server and the terminal. Then the DHCP server of the broadband access network is arranged to include the new DHCP option, including info on tunnel endpoint, in a DHCP message, e.g. a DHCPOFFER and/or a DHCPACK message, towards the terminal, even if the DHCP server is acting as a relay agent between the terminal and a DHCP server in an operator shop. If the new DHCP option is used in conjunction with a home NAT, the NAT itself is first configured via DHCP and then the NAT in turn configures the connecting terminals, including the new DHCP option. The DHCP method of informing the terminal allows the mechanism, including informing the terminal and the subsequent tunnel establishment, and even the user authentication depending on the authentication method, to be automated and handled by software in the terminal without user intervention. The necessary changes of the DHCP software used in the server and the terminal are obvious and can be easily implemented by a person skilled in the art using the corresponding RFCs describing the use of options in general in the DHCP protocol. Also, the DHCP software in the NAT can be modified to achieve the desired behaviour by a person skilled in the art.

A home NAT that uses an MAC address access control list, i.e. a list of allowed MAC addresses, could optionally use the new DHCP option for additional features. It could for instance choose to send the new DHCP option only to terminals having MAC addresses that are not on the list of allowed MAC addresses. Then it could apply packet filtering such that packets from these terminals are discarded unless they are sent to the address provided in the new DHCP option, i.e. the tunnel endpoint address.

A third possibility to inform the terminal is to convey the information about the tunnel endpoint via off-line means. For example, each household connected to a broadband access network can receive a letter from the operator of the broadband access network containing general information e.g. about the broadband access network, the connected operator shops, the available free services in the local service network, how to connect the equipment at home, etc. Such information could include FQDNs or IP addresses to be used for IPsec tunnel endpoints, in the case where the respective procedures are used.

Access Through an IPsec Tunnel to an Operator Shop Specific Endpoint in the BRAS

In this procedure each operator shop connected to the broadband access network has a dedicated tunnel endpoint. The dedicated tunnel endpoints may be given as dedicated addresses in the local VRF, or in a dedicated tunnel endpoint device, or preferably as a dedicated address in each of the VRFs that are associated with an operator shop.

In the former case the tunnel establishment mechanisms are basically the same as in the variant using a common tunnel endpoint. The only difference is that the operator shop selection is not solely based on the realm part of the NAI, but also on the selected tunnel endpoint. If the supplied realm and the selected tunnel endpoint do not indicate the same operator shop, the tunnel establishment may optionally be rejected.

If the dedicated tunnel endpoints are distributed to the different VRFs, then a tunnel endpoint does not have to be associated with a route to another VRF. Instead the VRF routes the packets coming out of the tunnel like all other packets coming from the broadband access network, i.e. to the operator shop to which the VRF is dedicated, unless the packet has a destination address from the address range of the broadband access network, indicating e.g. the local service network. However, in the downlink direction, the VRF still has to establish a host route for the “inner” IP address of the terminal, pointing to the tunnel interface, so that downlink packets addressed to the terminal are sent through the tunnel to the terminal instead of being routed to the service VLAN associated with the VRF, like other downlink packets. Also in this case the realm part of the NAI should, unless the user is roaming in a foreign broadband access network, indicate the same operator shop as that to which the selected tunnel endpoint belongs.

The IPsec tunnel may also be established via the local default VLAN, or via a WLAN AP and a service VLAN or the local WLAN AP VLAN.

The ways to inform the terminal about the available potential tunnel endpoints are basically the same as when a single common endpoint is used. A difference is that the new DHCP option in this case contains a list of tunnel endpoints, each identified by the realm, and possibly the name, of the associated operator shop followed by a FQDN or an explicit IP address. Alternatively, the new DHCP option can contain a single tunnel endpoint, but instead appear a plurality of times in the DHCP message, once for each dedicated tunnel endpoint.

Access Through an IPsec Tunnel to the Broadband Access Server

The simplest way to establish an IPsec tunnel from the terminal to the BAS of a selected operator shop is to use the regular IPsec establishment mechanisms and make no difference between this IPsec tunnel and other IPsec tunnels that a terminal may establish. However, it would mean that the IPsec tunnel is routed through the operator shop that is associated with the RG port, unless the RG port is associated with the local default VLAN. As a consequence, the resources of that operator shop, e.g. operator shop 1, and possibly other resources on the Internet, would have to be used, resulting in suboptimal routing and unnecessary charges for the subscriber of operator shop 1. In the case illustrated in FIG. 2e, it is assumed that the RG port is associated with operator shop 1, whereas the terminal wishes to access operator shop 2 through an IPsec tunnel to the BAS of operator shop 2. The tunnel then extends from the terminal via the RG, the AN, VLAN 1, VRF 1, the BAS of operator shop 1, the Internet and ending in the BAS of operator shop 2.

A more attractive method is to establish host routes in all VRFs, including the local VRF, to the BAS tunnel endpoints of all the operator shops connected to the broadband access network. Then, instead of going through operator shops and external networks, the IPsec tunnels are routed internally between the VRFs in the BRAS. For example, VRF 1 has a host route for the tunnel endpoint in the BAS of operator shop 2, i.e. a routing table entry for the IP address of this tunnel endpoint, pointing to VRF 2 through the BRAS internal network. However, as mentioned above, if multiple operator shops connected to a broadband access network use overlapping address spaces, e.g. private addresses, then this solution will not work, unless the tunnel endpoint at the operator shop is a globally unique address, i.e. not from the overlapping private range.

Using the method of BRAS internal routing, the IPsec tunnel establishment becomes rather straightforward using IKEv2 with the NAT traversal detection option. The BAS and the AAA devices/modules of the operator shop handle the user authentication. The IPsec tunnel can be established via a service VLAN or the local default VLAN, whichever is currently associated with the concerned RG port. In addition, the IPsec tunnel may be established via a WLAN AP and a service VLAN or the local WLAN AP VLAN.

The ways of informing the terminal about the available potential tunnel endpoints are the same as for the procedure using multiple operator shop specific tunnel endpoints in the BRAS.

Operator Shop Selection in a Foreign Broadband Access Network

In a foreign broadband access network, which herein is taken to refer to a broadband access network that has no relation or connection to the home operator shop of the user, the operator shop selection is a much more complex matter than in the home broadband access network. The reason is that a regular NAI cannot be used to indicate the operator shop that the user desires to visit. The NAI indicates the home operator shop of the subscriber, but it provides no indication of the operator shop that is the desired operator shop.

The main cases that should be considered in a foreign broadband access network include:

The user accesses the broadband access network through a CPN.

The user accesses the broadband access network through a WLAN AP.

The user accesses the broadband access network through an IPsec tunnel.

Access Through a CPN

In this case is easier to achieve operator shop selection, if there is specific support for the process in the client software, i.e. extra or modified software in addition to the support for EAP. However, the roaming architecture becomes more general and can easier encompass roaming users from other types of networks, if no specific support is required in the client software. Both these cases are considered below.

Access Through a CPN with Support in Software of Terminal

The procedure for this case relies on the concept of a modified NAI of the previously described general extended format. In this case the NAI is extended to include the realm of the selected operator shop that the user wants to visit. Thus, in this case the extended NAI has the format “home-op-shop/name@visited-op-shop” or “home-op-shop!name@visited-op-shop”, where “home-op-shop” is the realm of the home operator shop, “visited-op-shop” is the realm of the selected operator shop that the user wants to visit and “name” is the user's username.

For producing such an extended NAI the terminal software can allow

Manual selection, i.e. that the user enters his choice into the terminal, and

Automatic selection, i.e. the terminal software includes a routing selecting an operator shop from a configured list of preferred visited operator shops.

As previously described, the communication from/with a user or terminal who is connecting to an RG port, without a previously active session, is by default directed to the local default VLAN, where the EAP authentication procedure is initiated, by the Authenticator and the AAA client of the BRAS. If the terminal is to supply an extended NAI of the above described format during the authentication procedure, the terminal requires information about the operator shops that are available, i.e. the operator shops that are connected to the broadband access network to which the RG port is connected through an AN. The broadband access network can provide this information in different ways.

a) A first way for the broadband access network to advertise the available operator shops is the method suggested to be used in 3GPP-WLAN interworking. This method is described in Farid Adrangi (Ed.), “Mediating Network Discovery and Selection”, Internet draft, <draft-adrangi-eap-network-Discovery-and-Selection01.txt>, February 2004 (work in progress). The basic concept is that the operator shop information is provided to the terminal via EAP, in the case where the broadband access network receives a NAI with an unrecognized realm part, i.e. a realm for which there is no available AAA route, from the terminal. The user or terminal then selects one of the advertised operator shops and provides a second NAI to the network, this time an extended NAI of the format described above.
b) A second way for the broadband access network to advertise the available operator shops is to use a new link layer protocol to broadcast the information in the local default VLAN.
c) A third way is to let the user retrieve the operator shop information through off-line means.
d) Alternative methods that do not rely on information provided by the broadband access network have been described and in these methods either the terminal is designed to transfer a list of preferred visited operator shops to the broadband access network, and the network is made do the very selection, or they rely on support from a central Diameter redirect agent.

In any case, following a successful user authentication the BRAS instructs the concerned AN, e.g. via SNMP or some other protocol that the BRAS can use in the control of ANs, to associate the concerned RG port VLAN with the service VLAN associated with the selected operator shop, e.g. VLAN 1 if operator shop 1 is selected, instead of the local default VLAN. Then the user can proceed to acquire an IP address via DHCP to enable subsequent IP communication. In order for the BRAS to know which AN to instruct virtual MAC must be used.

In the description above the AAA client is assumed to be located in the BRAS, closely connected to the local VRF, but if the AAA client is located in the AN, neither the local default VLAN nor virtual MAC are needed for the purpose of changing the association.

If access only to the local service network is desired, the user, just as in the case of access through the home broadband access network, can supply a special NAI, with a realm part belonging to the broadband access network, dedicated for this purpose. The AN could then keep its association between the concerned RG port VLAN and the local default VLAN.

Access Through a CPN without Support in Software of Terminal

As previously described, when a user or terminal connects to an RG port, without a previously active session, he/it is for communication by default directed to the local default VLAN, where the EAP authentication procedure is initiated by the Authenticator and the AAA client of the BRAS.

Since the software of the terminal in this case has no support for the operator shop selection procedure, the terminal cannot receive operator shop information advertised by the broadband access network, irrespective of whether it is advertised using EAP or a new link layer protocol (alternatives a) and b) above). Thus the terminal will supply the user's regular NAI to the broadband access network, unless the user has acquired operator shop information off-line and manually extended the NAI.

When faced with a non-routable NAI, the broadband access network, in particular the BRAS thereof, is in this case arranged to bypass the actual authentication procedure, by immediately sending an EAP success packet, granting the user access to the local service network and keeping the default association between the RG port VLAN and the local default VLAN. Before sending the EAP success packet the broadband access network may optionally send an EAP notification request packet to the terminal with a displayable message instructing the user to start his browser to select an operator shop, or publicly available services in the local service network.

Thereupon, when the user uses his browser, after acquiring an IP address from the address space of the broadband access network, he is redirected to a web page on the service portal of the broadband access network, unless he attempts to access a web page in the local service network. On this web page the user can select between the available operator shops as well as services from the local service network.

If the user selects access to local services, the VLAN association and the IP address can remain as they are.

If the user clicks on one of the operator shops, this triggers the BRAS to do the following:

1. The BRAS forces the DHCP client in the user's terminal into the INIT state using a DHCP force renew procedure and a subsequent rejection of the client's request to prolong its IP address lease.
2. The BRAS initiates a new EAP procedure towards the terminal, this time with the user's selected operator shop stored.

This new EAP procedure will start in the same way as the previous one, but this time the BRAS knows to which operator shop the resulting AAA request is to be routed. Thus it is ensured that the AAA request ends up in the selected operator shop irrespective of which NAI the user provides. One way to achieve this is to let the EAP authenticator unit in the BRAS modify the NAI into the extended format before handing it over to the AAA client of the BRAS, but the AAA request may also be routed to the selected operator shop without an NAI modification, since the BRAS, that holds the knowledge about the selected operator shop, comprises both the EAP authenticator unit, the AAA client and the AAA proxy server.

If the BRAS fails to initiate the second EAP procedure, or if the authentication fails, the operator shop selection information, which was associated with the virtual MAC address used for the concerned user, or the MAC address of the user's terminal if virtual MAC is not used, eventually times out and is deleted.

Another method that can be used in this case is a method that relies on support from a central Diameter redirect agent.

3. Following a successful user authentication the BRAS instructs the concerned AN, e.g. via SNMP, or some other protocol that the BRAS can use to control ANs, to associate the concerned RG port VLAN with the service VLAN associated with the selected operator shop, e.g. VLAN 1 if operator shop 1 is selected, instead of the local default VLAN. Then the user can proceed to acquire an IP address via DHCP to enable subsequent IP communication. In order for the BRAS to know which AN to instruct virtual MAC must be used.

In the description above the AAA client is assumed to be located in the BRAS, connected to the local VRF, but if the AAA client is located in the AN, virtual MAC is not needed for this purpose, but the BRAS then has to be capable of triggering the AN to reinitiate the EAP procedure towards the terminal, and possibly inform the AN of the selected operator shop, e.g. using SNMP or some other protocol that the BRAS can use to control ANs.

If access only to the local service network is desired, the user, as in the case of access through the home broadband access network, could supply a special NAI, having a realm part belonging to the broadband access network, dedicated for this purpose. The AN could then keep its association between the concerned RG port VLAN and the local default VLAN.

Access Through a WLAN AP Supporting the Virtual AP Concept

For a WLAN AP that supports the virtual AP concept the access procedure is as follows.

As described above, when a user or terminal accesses the broadband access network through a WLAN AP, he/it must use the SSID associated with the operator shop that he has selected. Guiding information, in addition to the contents of the SSIDs themselves, may be obtained beforehand from the service portal that can be reached by the user first attaching to the WLAN AP using the SSID associated with the local WLAN AP VLAN.

The WLAN AP will then ensure that the AAA request resulting from the EAP procedure is routed to the selected operator shop, either

by modifying the NAI into the extended format, such as “home-op-shop/name@op-shop-realm-associated-with-selected-SSID” or “home-op-shop!name@op-shop-realm-associated-with-selected-SSID”, or

by conveying the used SSID to the AAA proxy server in a vendor specific attribute, or other AAA extension.

Access Through a WLAN AP not Supporting the Virtual AP Concept

If the WLAN AP does not support the virtual AP concept, the access procedure is similar to that described for access through a CPN for a roaming user. In this case an AN is used between the WLAN AP and the BRAS, see FIG. 2b. Furthermore, the VLANs illustrated in FIG. 2a that extend all the way to the WLAN AP, i.e. VLAN 1, VLAN 2 and the local WLAN AP VLAN, do not encompass the link between the AN and the WLAN AP, but instead ends in the AN. No VLAN is be needed between the WLAN AP and the AN, i.e. no local WLAN AP VLAN is needed.

If there is specific support for operator shop selection in the client software, the access procedure is more or less similar to that using extended NA1s, as described for the case of access through a CPN. Informing the terminal about the available operator shops can be done in the same way and the previously described methods mentioned above can also be used.

A difference is that the AAA client is located in the WLAN AP instead of in the BRAS. The AAA request resulting from the EAP authentication procedure is routed to the BRAS AAA proxy server and the AAA client of the WLAN AP includes the MAC address of the terminal in the AAA request. During, or immediately following, the authentication procedure the home operator shop AAA server provides one or more session keys, possibly produced as a by-product in the authentication procedure, to the WLAN AP to be used for the cryptographic protection mechanisms of IEEE 802.11i. As before, following a successful user authentication the BRAS instructs the AN, e.g. using SNMP or some other protocol that the BRAS can use to control ANs, to associate the user's current MAC address with the service VLAN of the selected operator shop, e.g. VLAN 2 if operator shop 2 was selected. Then the user can proceed to acquire an IP address via DHCP to enable subsequent IP communication.

If there is no support for the operator shop selection in the client software, extended NA1s cannot be used. Instead the BRAS AAA proxy server is arranged to immediately approve of the user authentication, when it is faced with a nonroutable AAA request, i.e. an AAA request including a destination realm for which the AAA proxy server has no route. The BRAS instructs the AN to associate the MAC address of the user's current terminal, which was received in the AAA request, with the local WLAN AP VLAN. The result is of course the same if the BRAS sends no instructions at all to the AN. Optionally the AAA proxy server may send an EAP notification request to the terminal with a displayable string encouraging the user to start his browser to be used for operator shop selection.

The user now has access to the local service network and the service portal. On the service portal, to which the user's browser is redirected if trying to access an external web page, the user can find information about available operator shops. The user selects an operator shop, or local services, by clicking on one of them. The user's current MAC address is then associated with the choice and stored in the BRAS. Then, unless the user selected access to local services, the terminal is forced to abandon its IP address, as described for the case of access through a CPN.

If the AAA protocol is Diameter, the next step is for the AAA proxy server to request the WLAN AP to re-authenticate the terminal through a Re-Auth-Request message. The AAA proxy server matches the subsequent AAA request with the stored operator shop selection through the terminal MAC address that the AAA client includes in the AAA request. This time the AAA messages carrying the EAP procedure are routed between the WLAN AP and the home AAA server via the AAA server of the selected operator shop. The reauthentication triggers IEEE 802.11i mechanisms to be initiated and after that the AAA client in the WLAN AP initiates a new accounting subsession, which clearly distinguishes any accounting data preceding the re-authentication from accounting data subsequent to the re-authentication procedure. Possibly, the same method can be used, if the AAA protocol is RADIUS. In the worst case the terminal would have to re-connect and initiate a new EAP procedure itself.

This procedure leaves the WLAN AP unaffected and can thus be used with available off-the-shelf APs.

If no AN is used between the WLAN AP and the BRAS, the BRAS must send its instructions to the WLAN AP and the WLAN AP must include a unit for receiving such instructions and for associating the user's MAC address with one out of several VLANs, these VLANs in this case extending all the way to the WLAN AP, according to the received instructions.

The layer 3 solution, based on IPsec tunnels, can also be used by a user/terminal accessing the broadband access network through a WLAN AP.

Access Through an IPsec Tunnel

The variants of the IPsec tunnel based layer 3 solution are the same as for the case of a user accessing his home broadband access network.

The procedures using a dedicated tunnel endpoint for each connected operator shop can be entirely reused from the home broadband access network case. It is the task of the AAA server of the selected operator shop to route the AAA requests to the home AAA server of the user.

However, the procedure using a single common tunnel endpoint for all connected operator shops has to be modified.

The IPsec tunnel to the local VRF in the BRAS, or a dedicated tunnel endpoint device, is established in the same way as described for a user accessing his home broadband access network. However, since neither the tunnel endpoint itself nor the regular NAI provided by the terminal indicates to which of the connected operator shop the AAA requests, and subsequent user data, are to be routed, extensions to the procedure are needed. During the EAP procedure the user can instead indicate the selected visited operator shop through an extended NAI, of the previously described format “home-op-shop/name@visited-op-shop” or “home-op-shop!name@visited-op-shop”.

If the user does not supply an extended NAI, the EAP based advertising of operator shop information can be used to let the user or terminal select one of the available operator shops and include the realm thereof in a subsequently transferred extended NAI, as described in the cited standard text Farid Adrangi (Ed.), “Mediating Network Discovery and Selection”, Internet draft, <draft-adrangi-eap-network-Discovery-and-Selection01.txt>.

Before forwarding an AAA request the AAA proxy server may turn the extended NAI into a regular NAI, having the format “name@home-op-shop” by deleting the “visited-op-shop” realm, moving the “home-op-shop” realm to the right of the “@” character and deleting the “/” or “!” character before the “name” part.

The previously described methods mentioned above that rely on support from a central Diameter relay agent are also applicable to this case.

### ADVANTAGES

The methods and procedures as described herein allow a user/terminal that accesses a broadband access network to select an operator shop out of multiple operator shops connected to the broadband access network. This is possible for users roaming in their home broadband access networks as well as for users roaming in foreign broadband access networks.

Both layer 2 and layer 3 methods are provided in order to cope with a variety of access scenarios, including accessing the broadband access network through a dedicated RG port, a non-dedicated RG port, a home WLAN AP, a home NAT, and a public WLAN AP, provided by the broadband access network.

Hence, the methods and procedures as described herein and the accordingly modified components in a broad access network as described herein are an part of a multi-operator (shop) mobile broadband access network environment.

Core of the Invention

The core of the invention consists of mechanisms to support roaming users, both in home and foreign networks, in a broadband access network context with multiple operator shops. Two main areas are identified:

The layer 2 mechanisms that are used to associate a user/terminal with the service VLAN of a selected operator shop. Particularly important are the mechanisms used for users roaming in foreign broadband access networks.

The core of the invention also includes the layer 3 mechanisms. In particular how the IPsec tunnels are handled internally in the BRAS and how DHCP could be used to inform the terminal about an available potential tunnel endpoint or endpoints.

1. (canceled)

2. An access node in a broadband access network for selecting a service providing network from a plurality of service providing networks, said access node comprising:
a virtual local area network (VLAN) handling unit for storing and transmitting Ethernet frames from a user device to a plurality of VLANs which interface with the plurality of service providing networks; and
a control unit in communication with the VLAN handling unit, said control unit including means for directing the VLAN handling unit to transmit the Ethernet frames from the user device to one of the VLANs identified by a broadband remote access server (BRAS).

3. The access node as recited in claim 2, wherein the means for directing the VLAN handling unit to transmit the Ethernet frames includes logic which causes the VLAN handling unit to initially transmit the Ethernet frames to a first VLAN, wherein the first VLAN includes the access node and a local virtual router function (VRF) of the BRAS.

4. The access node as recited in claim 3, wherein the means for directing the VLAN handling unit to transmit the Ethernet frames also includes:
communication means for receiving routing instructions from the BRAS identifying a second VLAN; and
logic which causes the VLAN handling unit to transmit the Ethernet frames to the second VLAN in response to the routing instructions, wherein the second VLAN includes the access node, the local VRF, and a VRF of the BRAS which transfers Ethernet frames to a broadband access server of one of the service providing networks.

5. A method in a broadband access network for selecting a service providing network from a plurality of service providing networks, said method comprising the steps of:
storing in a virtual local area network (VLAN) handling unit in an access node, Ethernet frames from a user device communicating with the access node;
initially transmitting the Ethernet frames from the VLAN handling unit to a first VLAN, wherein the first VLAN includes the access node and a local virtual router function (VRF) of a broadband remote access server (BRAS);
receiving routing instructions from the BRAS identifying a second VLAN, wherein the second VLAN includes the access node, the local VRF, and a VRF of the BRAS which transfers Ethernet frames to a broadband access server of one of the service providing networks; and
transmitting the Ethernet frames from the VLAN handling unit to the second VLAN in response to the routing instructions.

6. The method as recited in claim 5, wherein the step of receiving routing instructions from the BRAS includes receiving the routing instructions in a control unit in the access node, said control unit causing the VLAN handling unit to transmit the Ethernet frames to the second VLAN in response to the routing instructions.

7. A system in a broadband access network for selecting a service providing network from a plurality of service providing networks, said system comprising:
an access node;
a broadband remote access server (BRAS) in communication with the access node; and
a plurality of virtual local area networks (VLANs) in communication with the access node and the BRAS, wherein each VLAN interfaces with a different service providing network;
wherein the access node includes:
a virtual local area network (VLAN) handling unit for storing and transmitting Ethernet frames from a user device to the plurality of VLANs; and
a control unit in communication with the VLAN handling unit, said control unit including means for directing the VLAN handling unit to transmit the Ethernet frames from the user device to one of the VLANs identified by the BRAS.

8. The system as recited in claim 2, wherein the means for directing the VLAN handling unit to transmit the Ethernet frames includes logic which causes the VLAN handling unit to initially transmit the Ethernet frames to a first VLAN, wherein the first VLAN includes the access node and a local virtual router function (VRF) of the BRAS.

9. The system as recited in claim 3, wherein the means for directing the VLAN handling unit to transmit the Ethernet frames also includes:
communication means for receiving routing instructions from the BRAS identifying a second VLAN, and
logic which causes the VLAN handling unit to transmit the Ethernet frames to the second VLAN in response to the routing instructions, wherein the second VLAN includes the access node, the local VRF, and a VRF of the BRAS which transfers Ethernet frames to a broadband access server of one of the service providing networks.
